(19) United States
(12) Patent Application Publication
(10) Pub. No.: US 2004/0202790 A1
(43) Pub. Date: Oct. 14, 2004

(54) Method and apparatus for producing photothermographic material

(75) Inventor: Kenichi Ogata, Fujinomiya-Shi (JP)

Correspondence Address: YOUNG & THOMPSON, 745 SOUTH 23RD STREET 2ND FLOOR, ARLINGTON, VA, 22202

(73) Assignee: FUJI PHOTO FILM CO., LTD., MINAMI-ASHIGARA-SHI (JP)

(21) Appl. No.: 10/408,314

(22) Filed: Apr. 8, 2003

(51) Int. Cl. B05D 1/30; B05D 3/02

(52) U.S. Cl. 427/374.1; 427/372.2

(57) ABSTRACT

The surface temperature of a coating film after being applied and dried is quickly increased to a thermal treatment temperature in the range of from 60 to 100° C. in a heating zone of a thermal treatment device. Then, the surface temperature of the coating film having been heat-treated is kept at the thermal treatment temperature for a time period in the range of 1 to 60 seconds in a thermal retaining zone. Then, the surface temperature of the coating film having been thermal-retaining-treated is forcefully decreased from the thermal treatment temperature to near a room temperature in a cooling zone. By the three-phase process in the thermal treatment device, the surface of the emulsion layer is prevented from stripping during processing such as slitting, a photothermographic material excellent in photographing performance can be obtained, and productivity is improved.

### BACKGROUND OF THE INVENTION

1. Field of the Invention

The present invention relates to a method and an apparatus for producing photothermographic materials, and particularly relates to a technique of thermal treatment after application and drying of the photothermographic material.

2. Description of the Related Art

In recent years, reduction in discharge of post-treatment wastes has been strongly desired in terms of environmental conservation and space savings in the areas of films for medical diagnosis and photoengraving films. Thus, a technique as to a photothermographic material as the film for medical diagnosis and photoengraving film capable of being exposed to light efficiently by a laser image setter or laser imager to form thereon a clear black image having a high level of resolution and sharpness is required. This photothermographic material has an advantage that no solution based treatment chemicals are required, heat development treatment systems simpler and harmless to environment can be provided to customers.

The photothermographic material is produced by drying in a drying step a coating film formed by applying at least an emulsion layer (photosensitive layer) coating solution containing an organic silver salt, a silver ion reducing agent, a polymer binder and a photosensitive silver halide on a continuously traveling substrate.

For the photothermographic material, the coating film may be stripped off during processing such as slitting, thus significantly degrading the product value unless a thermal treatment is carried out after the application and drying of the coating film. In addition, there rises a problem such that film chips stripped off the coating film are introduced in the coating film during processing to cause a serious failure in a spotted form after the thermal treatment.

Therefore, conventionally, the photothermographic material with the application and drying of the coating film surface completed is taken in a thermal treatment device kept at a fixed temperature, and is taken out from the thermal treatment device after a predetermined amount of time elapses. In addition, hitherto, there has no knowledge about influences on the above-described serious failure by the amount of time elapsed before the thermal treatment is started after the surface of the coating film formed by application is dried, and therefore the thermal treatment has been carried out usually by winding up the photothermographic material after the application and drying by a winding device, and thereafter treating the photothermographic material by a thermal treatment device capable of high temperature treatment installed separately from the production line for the photothermographic material.

Production of the photothermographic material by the separately installed conventional thermal treatment device has the following disadvantages:

(1) There may be cases where end portions of the photothermographic material should be slit in alignment for the width of the thermal treatment device, resulting in a loss of end portions.

(2) The thermal treatment device is a batch type device, which is poor in treatment efficiency.

(3) A step of thermal treatment is provided in addition to a series of steps of producing the photothermographic material, thus raising a disadvantage that a failure is more likely to occur in association of the addition of the step, and losses constantly brought about become significant.

These disadvantages have caused problems of reduction in productivity.

### SUMMARY OF THE INVENTION

The present inventor has studied conditions for thermal treatment such as the amount of time elapsed before the thermal treatment is started after the surface of the coating film formed by application is dried to achieve an improvement in quality of the photothermographic material by further improving the thermal treatment performance.

The present invention has been devised in view of such situations, and has as its object provision of a method and an apparatus for producing photothermographic materials in which photothermographic materials excellent in film characteristics of the coating film and stability of sensitivity of the emulsion layer can be obtained due to the improvement of thermal treatment performance, and productivity in the production of the photothermographic materials can be enhanced.

In order to attain the above-described object, the present invention is directed to a method for producing a photothermographic material, comprising the steps of: coating a continuously traveling substrate with at least an emulsion layer coating solution containing an organic silver salt, a silver ion reducing agent, a polymer binder and a photosensitive silver halide to thereby form a coating film on the substrate; drying the coating film; and performing a thermal treatment for the coating film after the drying step, wherein the thermal treatment includes: a heat treatment for quickly increasing a temperature of a surface of the coating film to a thermal treatment temperature in a range of from 60 to 100° C.; a thermal retaining treatment for keeping the surface temperature of the coating film after the heat treatment, at the thermal treatment temperature for a time period in a range of from 1 to 60 seconds; and a cooling treatment for forcefully decreasing the surface temperature of the coating film after the thermal retaining treatment, from the thermal treatment temperature to near a room temperature.

In order to attain the above-described object, the present invention is also directed to an apparatus for producing a photothermographic material, comprising: a coating device which coats a continuously traveling substrate with at least an emulsion layer coating solution containing an organic silver salt, a silver ion reducing agent, a polymer binder and a photosensitive silver halide to thereby form a coating film on the substrate; a drying device which dries the coating film; and a thermal treatment device which performs thermal treatment for the coating film, the thermal treatment device being arranged after the drying device, wherein the thermal treatment device includes the following zones in order from an upstream side along a traveling direction of the substrate: a heating zone for quickly increasing a temperature of a surface of the coating film to a thermal treatment temperature; a thermal retaining zone for keeping the surface temperature of the coating film at the thermal treatment temperature; and a cooling zone for forcefully decreasing the surface temperature of the coating film to near a room temperature.

According to the present invention, the surface temperature of the coating film having been applied and dried is quickly increased to the thermal treatment temperature in the range of from 60 to 100° C. in the heat treatment step. Then, the surface temperature of the coating film having been heat-treated is kept at the thermal treatment temperature for a time period in a range of from 1 to 60 seconds. Then, the surface temperature of the coating film having been thermal-retaining-treated is forcefully decreased from the thermal treatment temperature to near a room temperature. Due to the three-phase treatment in the thermal treatment, the surface of the emulsion layer is prevented from stripping during processing such as slitting, and thus a photothermographic material excellent in photographing performance can be obtained.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a block diagram of a photothermographic material producing apparatus;

FIG. 2 is a schematic diagram illustrating a thermal treatment device; and

FIGS. 3(a) and 3(b) are explanatory views illustrating a heating device of a heating zone in the thermal treatment device.

### DETAILED DESCRIPTION OF THE PREFERRED EMBODIMENTS

The preferred embodiments of a method and an apparatus for producing photothermographic materials according to the present invention will be described below in accordance with the accompanying drawings.

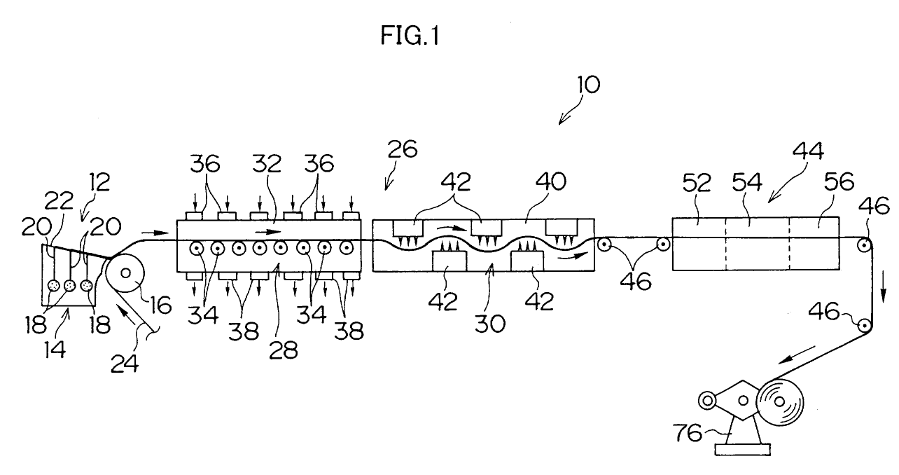

FIG. 1 is a block diagram of a photothermographic material producing apparatus 10 according to an embodiment of the present invention.

As shown in FIG. 1, a continuously traveling substrate 24 is coated simultaneously in stratification with a coating solution for forming an emulsion layer (photosensitive layer) of photothermographic material containing an organic silver salt, a silver ion reducing agent, a polymer binder and a photosensitive silver halide, a coating solution for a protective layer protecting the emulsion layer, and the like by a slide bead coating device 12.

The slide bead coating device 12 comprises a slide hopper 14 and a backup roller 16, wherein the coating solutions pushed out on a slide surface 22 tilted downward from a plurality of manifolds 18 of the slide hopper 14 through slits 20 are flowed down as a stratified liquid film. Then, a bead (reservoir of coating solution) is formed in a gap between the leading edge of the slide surface 22 and the substrate 24 continuously traveling while being wound around the backup roller 16, and the substrate 24 is coated simultaneously in stratification with the stratified liquid film. In this way, a coating film for producing the photothermographic material is formed on the substrate 24. In this case, the bead is preferably stabilized by providing negative pressure below the bead. Furthermore, the embodiment has been described using the slide bead coating device 12 as an example, but is not limited thereto, and any coating device capable of simultaneous coating in stratification such as, for example, a slide curtain coating device may be used.

The substrate 24 with the coating film formed thereon by the slide bead coating device 12 is transported to a drying device 26, where the coating film is dried.

The drying device 26 comprises a chilling device 28 cooling the coating film using cold air and a parallel type noncontact drying device 30 drying the coating film in a noncontact manner by applying hot dried air to the both surfaces of the substrate 24 to support the substrate by air floatation.

The chilling device 28 has a plurality of path rollers 34 arranged along the transportation line of the substrate 24 in a tunnel-shaped body 32 with both ends opened as inlet and outlet ports for the substrate 24, and the substrate 24 is transported on the path rollers 34 with the coating film surface facing upward. In addition, a plurality of supply ports 36 for supplying cold air into the body 32 are formed along the transportation line in the upper part of the body 32, and a plurality of discharge ports 38 for discharging cold air in the body 32 are formed in the lower part of the body 32. In this way, the coating film on the substrate 24 is cooled by cold air while traveling in the chilling device 28, whereby gelation of the coating film is promoted.

The parallel type noncontact drying device 30 is configured so that a plurality of air headers 42 blowing off dried air along the transportation line of the substrate 24 are placed in a tunnel-shaped body 40 with both ends opened as inlet and outlet ports for the substrate 24. The plurality of air headers 42 are placed in an alternate order along the transportation line of the substrate 24 on both upper and lower sides with the substrate 24 therebetween. Hot dried air adjusted so as not to cause irregularity in the surface of the coating film on the substrate 24 and the scattering of liquid is blown off from the air headers 42 placed in an alternate order to dry the coating film.

The substrate 24 with the coating film dried by the drying device 26 is transported to the thermal treatment device 44, where the coating film is thermally treated. In this case, the amount of time during which the substrate 24 is transported from the outlet port of the parallel type noncontact drying device 30 to the inlet port of the thermal treatment device 44 is preferably not greater than 60 seconds, particularly preferable not greater than 30 seconds.

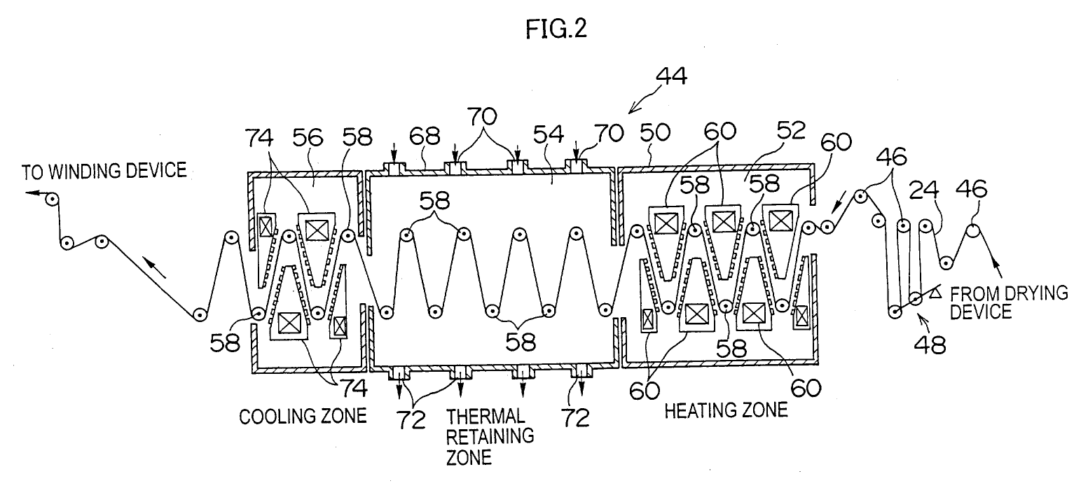

FIG. 2 is a schematic diagram illustrating the configuration of the thermal treatment device 44. Furthermore, the substrate 24 is transported from the right side to the left side in FIG. 2.

As shown in FIG. 2, the substrate 24 leaving the drying device 26 passes through a dancer roller 48 in the course of being guided to the thermal treatment device 44 by a plurality of guide rollers 46.

The thermal treatment device 44 comprises three zones of a heating zone 52 for increasing the surface temperature of the dried coating film to a thermal treatment temperature, a thermal retaining zone 54 for keeping the surface temperature of the coating film at the thermal treatment temperature and a cooling zone 56 for cooling the surface of the coating film down to a room temperature, in the descending order from the upstream of the traveling direction of the substrate 24, in a tunnel-shaped body 50.

The heating zone 52 has a plurality of path rollers 58 placed in an alternate order along the transportation line of the substrate 24 on both upper and lower sides with the substrate 24 therebetween. In this way, the substrate 24 travels in such a manner as to draw approximately a sine curve. Similarly, a plurality of heating devices 60 are placed in an alternate order along the transportation line of the substrate 24 on both upper and lower sides with the substrate 24 therebetween. In this way, the substrate 24 is heat-treated from both the coating film surface and the opposite surface.

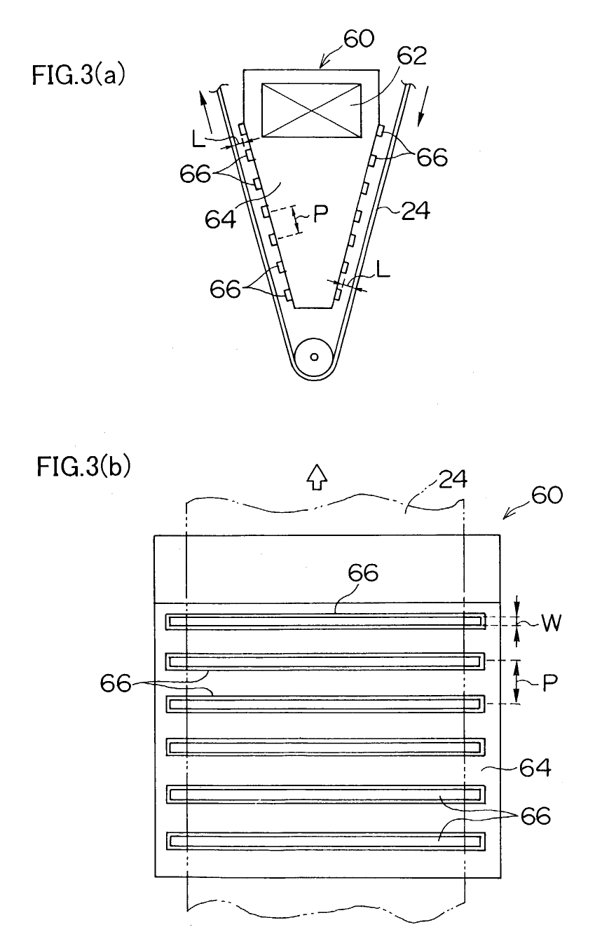

FIG. 3(a) is a side view of the heating device 60, and FIG. 3(b) is a plan view of the heating device 60.

As shown in these drawings, the heating device 60 is such that hot air is supplied from a hot air supplying device (not shown) through a duct 62 to a nozzle header 64, hot air is blown off toward the substrate 24 from a plurality of nozzles 66 provided in the nozzle header 64. The nozzle header 64 has a side face shaped into approximately a trapezoid so that the front face of the nozzle header 64 is situated along the transportation line (drawing approximately a sine curve) of the substrate 24. The nozzles 66 each having a long slot-shaped air outlet along the width of the substrate 24 are arranged at regular intervals (pitches) along the traveling direction of the substrate 24 in the front face of the nozzle header 64. The size of the pitch (P) between nozzles 66 is preferably in the range of from 150 to 500 mm, particularly preferably from 200 to 400 mm. The distance (L) between the leading edge of the nozzle 66 and the substrate 24 is preferably in the range of from 20 to 100 mm, further preferably from 20 to 80 mm, particularly preferably from 30 to 70 mm. The length (W) of the opening along the traveling direction of the substrate in the air outlet of the nozzle 66 is preferably in the range of from 2 to 10 mm, further preferably from 2 to 7 mm, particularly preferably 3 to 5 mm. The wind speed at the outlet of the nozzle 66 is preferably in the range of from 10 to 50 m/second, further preferably from 15 to 40 m/second, particularly preferably from 20 to 30 m/second. In addition, the temperature of hot air blown off from the nozzle 66 is preferably higher by at least 5° C. than the surface temperature of the coating film to be thermally treated. In this case, a temperature sensor (not shown) is preferably arranged near the nozzle 66 to feedback-control the temperature of hot air blown off from the nozzle 66.

This heating zone 52 plays a role to quickly increase the surface temperature of the coating film dried in the drying device 26 to a thermal treatment temperature. For the temperature at which the coating film is thermally treated, the surface temperature of the coating film is preferably in the range of from 60 to 100° C. The amount of time required for increasing the surface temperature of the coating film to the thermal treatment temperature is preferably not greater than 10 seconds. Furthermore, the heating device 60 of the heating zone 52 is preferably a type of device in which hot air is blown off from the nozzles 66 to heat both surfaces of the substrate 24 as described above, but is not limited thereto, and an atmosphere heating device similar to that in the thermal retaining zone 54 described below, a far-infrared heating device or a heat roll heating device may be used, or these heating devices may be combined in a variety of ways. In short, any heating device capable of heating the coated and dried coating film quickly to the thermal treatment temperature may be used.

As shown in FIG. 1, in the thermal retaining zone 54, a plurality of path rollers 58 are placed in an alternate order along the transportation line of the substrate 24 on both upper and lower sides with the substrate 24 therebetween as in the case of the heating zone 52. In this way, the substrate 24 travels in such a manner as to draw approximately a sine curve. In addition, a plurality of hot air supply ports 70 are formed in the upper part of a body 68, and a plurality of hot air discharge ports 72 are formed in the lower part of the body 68. Hot air is supplied to the hot air supply port 70 from a hot air supplying device (not shown) so that the atmosphere temperature in the thermal retaining zone 54 is kept at the thermal treatment temperature. In this way, for the thermal retaining zone 54, the atmosphere heating in which there is a breeze of air at the thermal treatment temperature in the thermal retaining zone 54 is carried out. In this case, the speed at which the air blows is preferably in the range of from 0.1 to 10 m/second at the surface of the substrate 24. The thermal retaining zone 54 plays a role to keep the surface temperature of the heat-treated coating film at the thermal treatment temperature. The amount of time during which the substrate stays in the thermal retaining zone 54 is preferably in the range of from 1 to 60 seconds. Furthermore, a type of heating device in which air is blown off from the nozzle can be used as a heating device in the thermal retaining zone 54 as in the case of the heating zone 52; in this case, the wind speed at the nozzle outlet is preferably in the range of from 1 to 30 m/second, further preferably from 3 to 15 m/second. What is essential is that the wind speed at the surface of the substrate 24 is preferably in the range of from 0.1 to 10 m/second.

In the cooling zone 56, a plurality of path rollers 58 are placed in an alternate order along the transportation line of the substrate 24 on both upper and lower sides with the substrate 24 therebetween, and a plurality of cooling devices 74 each having a structure the same as that shown in FIGS. 3(a) and 3(b) are placed in the same manner as the heating zone 52. Cool air is supplied to the cooling devices 74 from a cool air supplying device (not shown), and the substrate 24 is cooled from both the coating film surface and the opposite surface. The cooling zone 56 plays a role to forcefully decrease the surface temperature of the coating film thermal-retaining-treated in the thermal retaining zone 54 from the thermal treatment temperature to near a room temperature. A moisture conditioning device (not shown) is preferably provided in the cooling zone 56 to moisture-condition the surface of the coating film at a relative humidity of 40 to 90% in addition to the cooling treatment. The cooling devices 74 in the cooling zone 56 are preferably a type of device in which the both surfaces of the substrate 24 are cooled by blowing off cool air from the nozzles 66 as described above, but are not limited thereto, and an atmosphere cooling device in which a breeze of cool air is provided, or a cool roll cooling device may be used, or these cooling devices may be combined in a variety of ways. In short, any cooling device capable of forcefully cooling the coating film having been thermally treated in the thermal treatment zone 54 to near a room temperature may be used. In the case of cooling device using the nozzles 66, the wind speed at the outlet of the nozzles 66 is preferably in the range of from 10 to 50 m/second, further preferably from 15 to 40 m/second, particularly preferably 20 to 30 m/second.

In the above-described heating zone 52, thermal retaining zone 54 and cooling zone 56, hot air, cool air and moisture conditioning air may be used in circulation line systems, or a system may be used in which some air is introduced from the outside of the system and some air is discharged to the outside of the system. The type of transportation of the substrate 24 in the heating zone 52, the thermal retaining zone 54 and the cooling zone 56 is roller transportation by the path rollers 58 in the above-described embodiment, but is not limited thereto, and noncontact transportation by air floatation may be employed. In the case of roller transportation, the surface of the path rollers 58 to be used is preferably hard chrome-plated, but is not limited thereto, and other types of coatings, for example coating with polytetrafluoroethylene may be applied. The surface of the path rollers 58 may be flat or may be grooved, and the roll diameter is preferably in the range of from 80 to 200 mm.

The substrate 24 with the coating film thermally treated by the thermal treatment device 44 is wound up by a winding device 76 as shown in FIG. 1.

According to the photothermographic material producing apparatus 10 configured as described above, the thermal treatment device 44 is provided after the drying device 26, whereby the thermal treatment device 44 is incorporated in the production line for the photothermographic material so that the thermal treatment is completed within a time period between the time when the coating film is applied and dried and the time when the substrate 24 is wound up by the winding device 76. In this way, the thermal treatment can be carried out in a series of processes for producing the photothermographic material, and therefore productivity can significantly be improved, compared with the conventional technique, for at least the following reasons (1) to (3):

(1) The substrate 24 with the coating film having been applied and dried does not need to be thermally treated by a separately provided thermal treatment device unlike the conventional technique, and therefore it is not necessary to slit the end portion along the width of the substrate 24 in alignment with the width of the thermal treatment device. Thus, a slitting loss associated therewith does not occur.

(2) The thermal treatment can be carried out in a series of processes for producing the photothermographic material, thus making it possible to enhance a treatment capability.

(3) Since no additional step is provided in addition to a series of steps of producing the photothermographic material unlike the conventional technique, failures are less likely to occur and losses constantly brought about are reduced.

Furthermore, the thermal treatment device 44 incorporated in the photothermographic material producing apparatus 10 of the present invention is operated under the three-phase process carried out by the heating zone 52 for quickly increasing the surface temperature of the coating film to the thermal treatment temperature in the range of from 60 to 100° C., the thermal retaining zone 54 for keeping the surface temperature of the heat-treated coating film at the thermal treatment temperature for a time period in the range of 1 to 60 seconds, and the cooling zone 56 for quickly decreasing the surface temperature of the thermal-retaining-treated coating film from the thermal treatment temperature to near a room temperature, thus making it possible to improve the film characteristics of the coating film and sensitivity stability. Therefore, the surface of the emulsion layer is prevented from stripping during processing such as slitting, and thus a photothermographic material excellent in photographing performance can be obtained.

It is preferable that the speed at which the substrate 24 is transported (treatment speed) is in the range of from 30 to 300 m/minute. The thermal treatment device 44 is comprised of three blocks of the heating zone 52, the thermal retaining zone 54 and the cooling zone 56 in the above-described embodiment, but is not limited thereto. Each block may further be divided into a plurality of blocks, and the volume of one block is thus reduced, so that it is possible to control the temperature more easily and to improve the temperature efficiency.

Next, a photothermographic material preferably used in the present invention will be described in detail below.

Organic silver salts that can be used in the present invention are relatively stable to light; however, when heated to 80° C. or above in the presence of an exposed photocatalyst (latent image of light-sensitive silver halide and the like) and a reducer, they form silver images. The organic silver salts may be any organic substance containing a source that can reduce silver ions. Such non-light-sensitive organic silver salts are described in Japanese Patent Application Publication No. 10-62899, Paragraph Nos. 0048 and 0049; European Patent Application Publication No. 0803764A1, page 18, line 24 to page 19, line 37; European Patent Application Publication No. 0962812A1; Japanese Patent Application Publication No. 11-349591; Japanese Patent Application Publication No. 2000-7683; and Japanese Patent Application Publication No. 2000-72711. Silver salts of organic acids, and particularly preferable are the silver salts of long-chain aliphatic carboxylic acids (of which the number of carbon atoms is 10 to 30, preferably 15 to 28). Preferable examples of the organic silver salts include silver behenate, silver arachidate, silver stearate, silver oleate, silver laurate, silver capronate, silver myristate, silver palmitate, and the mixture thereof. Of these organic silver salts, the use of an organic silver salt containing 75 mol % or more silver behenate is preferable in the present invention.

The form of the organic silver salts that can be used in the present invention is not specifically limited, and may be needle-like, bar-like, plate-like, and flake-like.

In the present invention, flake-like organic silver salts are preferable. The flake-like organic silver salts are herein defined as follows. When an organic silver salt is observed through an electron microscope, the form of a particle of the organic silver salt is approximately a rectangular parallelepiped, and when the edges of the rectangular parallelepiped are named as a, b, and c from the shortest edge (c may be the same as b), x is calculated from the shorter values a and b as follows:

x=b/a

Thus, x is calculated for about 200 particles, and when the average is called averaged value x (average), particles that satisfy the relationship of x (average) ≧1.5 are defined as flake-shaped. Preferably, 30≧x (average) ≧1.5, and more preferably, 20>x (average) >2.0. For reference, a needle-like particle is defined as 1≦x (average) ≦1.5.

In a flake-like particle, a can be deemed as the thickness of a plate-like particle that has the face having sides b and c as the principal face. The average of a is preferably 0.01 μm to 0.23 μm, and more preferably 0.1 μm to 0.20 μm. The average of c/b is preferably 1 or more and 6 or less, more preferably 1.05 or more and 4 or less, further preferably 1.1 or more and 3 or less, and most preferably 1.1 or more and 2 or less.

The distribution of the particle sizes of the organic silver salt is preferably simple distribution. Simple distribution is the distribution when the percentage of the value obtained by dividing the standard deviations of the lengths of the minor axis and the major axis by the minor axis and the major axis, respectively, is 100% or below, more preferably 80% or below, and further preferably 50% or below. The form of the organic silver salt can be measured from the transmission electron microscope image of the dispersion of the organic silver salt. Another method for measuring simple distribution is a method to calculate the standard deviation of the volume-weighted average of the organic silver salt, and the percentage of the value obtained by dividing the standard deviation by the volume-weighted average (coefficient of variation) is preferably 100% or below, more preferably 80% or below, and further preferably 50% or below. The coefficient of variation can be obtained from the particle size (volume-weighted average diameter) obtained by radiating laser beams to the organic silver salt dispersed in a liquid, and obtaining the autocorrelation function for change in time of the wobble of the scattered light.

Known methods can be applied to the method for manufacturing an organic silver salt used in the present invention and to the method for dispersing it. For example, the above-described Japanese Patent Application Publication No. 10-62899, European Patent Application Publication No. 0803764A1, European Patent Application Publication No. 0962812A1; Japanese Patent Application Publication No. 11-349591; Japanese Patent Application Publication No. 2000-7683; and Japanese Patent Application Publication No. 2000-72711, Japanese Patent Application No. 11-348228, Japanese Patent Application No. 11-348229, Japanese Patent Application No. 11-348230, Japanese Patent Application No. 11-203413, Japanese Patent Application No. 2000-90093, Japanese Patent Application No. 2000-195621, Japanese Patent Application No. 2000-191226, Japanese Patent Application No. 2000-213813, Japanese Patent Application No. 2000-214155, Japanese Patent Application No. 2000-191226, and the like can be referred to.

If a light-sensitive silver salt is allowed to coexist when the organic silver salt is dispersed, fog increases and sensitivity lowers significantly; therefore, it is preferable not to substantially contain light-sensitive silver salts when the organic silver salt is dispersed. In the present invention, the content of light-sensitive silver salts in the aqueous dispersion is 0.1 mol% or less to 1 mole of the organic silver salt in the dispersion, and the light-sensitive silver salts are not intentionally added.

In the present invention, although a light-sensitive material can be manufactured by mixing an aqueous dispersion of an organic silver salt and an aqueous dispersion of a light-sensitive silver salt, and the mixing ratio of the organic silver salt and the light-sensitive silver salt can be selected depending on the purpose, the percentage of the light-sensitive silver salt to the organic silver salt is preferably within a range between 1 mol% and 30 mol%, more preferably within a range between 3 mol% and 20 mol%, and most preferably within a range between 5 mol% and 15 mol%. Mixing two or more aqueous dispersions of organic silver salts and two or more aqueous dispersions of light-sensitive silver salts is a method preferably used for the control of photographic performance.

Although any desired quantity of an organic silver salt can be used in the present invention, the quantity as silver is preferably 0.1 g/m² to 5 g/m², and more preferably 1 g/m² to 3 g/m².

It is preferable that the photothermographic material of the present invention contains a reducer for organic silver salts. The reducer for organic silver salts may be any substance (preferably an organic substance) that reduces silver ions to metallic silver. Such reducers are described in Japanese Patent Application Publication No. 11-65021, paragraphs 0043 to 0045; or European Patent Application Publication No. 0803764A1, page 7, line 34 to page 18, line 12. In the present invention, bisphenol reducing agents (e.g. 1,1-bis(2-hydroxy-3,5-dimethylphenyl)-3,5,5-trimethylhexane, 2,2′-methylenebis-(4-methyl-6-tert-butylphenol), 2,2′-methylenebis-(4-ethyl-6-tert-butylphenol)) are particularly preferable. The mount of added reducing agent is preferably in the range of from 0.01 to 5.0 g/m², more preferably from 0.1 to 3.0 g/m², and the content of reducing agent is preferably in the range of from 5 to 50 mol%, more preferably from 10 to 40 mol% with respect to 1 mole of silver of the surface having an image forming layer. The reducing agent is preferably incorporated in the image forming layer.

The reducer may be contained in the coating liquid and therefore in the light-sensitive material in any form, such as a dissolved form, an emulsified and dispersed form, and a dispersed fine solid particle form.

One of well-known emulsifying and dispersing methods is a method wherein a reducer is dissolved in oil, such as dibutyl phthalate, tricresyl phosphate, glyceryl triacetate, and diethyl phthalate; or an auxiliary solvent, such as ethyl acetate and cyclohexanone; and then the emulsion is mechanically formed.

Fine solid particle dispersing methods include a method wherein the powder of a reducer is dispersed in a suitable solvent, such as water, using a ball mill, a colloid mill, a vibrating ball mill, a sand mill, a jet mill, a roller mill, or ultrasonic waves to form a solid dispersion. In this time, a protective colloid (for example, polyvinyl alcohol) or a surfactant (for example, an anionic surfactant, such as sodium triisopropylnaphthalenesulfate (mixture of compounds wherein three isopropyl groups are bonded to different substitution sites)) may be used. The aqueous dispersion may contain an antiseptic agent (for example, benzoisothiazolinone sodium salt).

In the photothermographic material of the present invention, a phenol derivative represented by equation (A) described in Japanese Patent Application No. 11-73951 is preferably used as a developing accelerator.

When the reducer in the present invention has an aromatic hydroxyl group (—OH), especially in the case of the above-described bisphenols, the combined used of a non-reducing compound having groups capable of forming a hydrogen bonds with these groups is preferable. Groups that form hydrogen bonds with hydroxyl or amino groups include phosphoryl, surfoxide, sulfonyl, carbonyl, amide, ester, urethane, ureido, tertiary amino, and nitrogen-containing aromatic groups. The preferable of these are compounds having a phophoryl group, a sulfoxide group, an amide group (having no >N—H groups, and blocked as >N—Ra (Ra is a substituent other than H)), a urethane group (having no >N—H groups, and blocked as >N—Ra (Ra is a substituent other than H)), and a ureido group (having no >N—H groups, and blocked as >N—Ra (Ra is a substituent other than H)).

The particularly preferable hydrogen-bondable compound in the present invention is a compound represented by the following general formula (II).

Halogen components in light-sensitive silver halides used in the present invention are not specifically limited, and silver chloride, silver chlorobromide, silver bromide, silver iodobromide, and silver iodochlorobromide can be used. Of these, silver bromide and silver iodobromide are preferable. The halogen components in a silver halide particle may be evenly distributed, may change stepwise, or may change continuously. Silver halide particles having a core-and-shell structure may also be preferably used. The core-and-shell structure that can be used is preferably a two-layer to five-layer structure, and more preferably a two-layer to four-layer structure. The technique for allowing silver bromide to be locally present on the surfaces of silver chloride or silver chlorobromide particles can also be preferably used.

Methods for forming light-sensitive silver halide are well known to the skilled in the art, and the method described in Research Disclosure, No. 17029, June 1978 and U.S. Pat. No. 3,700,458 can be used. Specifically, a light-sensitive silver halide is formed by adding a silver-providing compound and a halogen-providing compound in a solution of gelatin or other polymers, and then it is mixed with an organic silver salt. Also preferably used are method described in Japanese Patent Application Publication No. 11-119374, paragraphs 0217 to 0224, and Japanese Patent Application Nos. 11-98708 and 2000-42336.

It is preferably that the particle size of the light sensitive silver halide is small for inhibiting clouding after forming images. Specifically, it is preferably 0.2 μm or smaller, more preferably 0.01 μm or larger and 0.15 μm or smaller, and most preferably 0.02 μm or larger and 0.12 μm or smaller. The particle size mentioned here refers to a diameter equivalent to that of a ball having a volume equivalent to that of the silver halide particle if the silver halide particle is so called a normal crystal having a shape of cube or octahedron, or a non-normal crystal, for example, a spherical particle and a rod particle, and refers to a diameter equivalent to that of a circular image having of which the area equals the projected area of the main surface if the silver halide particle is a flat particle.

The shapes of the silver halide particles include cubic, octahedral, tabular, spherical, rod-like, and potato-like. In the present invention, cubic particles are particularly preferable. Silver halide particles having rounded corners can also be preferably used. The plane index (Miller index) of the outer surfaces of light-sensitive silver halide particles is not specifically limited; however, it is preferable that the percentage of {100} planes, which has a high spectral sensitization efficiency when spectral sensitization dyes are adsorbed, is high. The percentage is preferably 50% or more, more preferably 65% or more, and most preferably 80% or more. The Miller index, the percentage of {100} planes, can be obtained using the method that utilizes the adsorption dependency of {111} planes and {100} planes in the adsorption of the sensitizing dyes, described in T. Tani; J. Imaging Sci., 29, 165 (1985).

The light-sensitive silver halide particles of the present invention can contain metals or metal complexes of groups 8 to 10 in the periodic table (from group 1 to group 18). The preferable metals in metals or metal complexes of groups 8 to 10 are rhodium, ruthenium, and iridium. These metal complexes may be used alone, or in combination of two or more metals of the same group or of different groups. The content is preferably within a range between 1×10⁻⁹ mole and 1×10⁻³ mole to 1 mole of the silver. These heavy metals, metal complexes, and methods for the addition thereof are described in Japanese Patent Application Publication No. 7-225449; Japanese Patent Application Publication No. 11-65021, paragraph Nos. 0018 to 0024; and Japanese Patent Application Publication No. 11-119374, paragraph Nos. 0227 to 0240.

In the present invention, the iridium compound is particularly preferably incorporated in the silver halide particle. Iridium compounds include, for example, hexachloro iridium, hexamine iridium, trioxalate iridium and hexacyano iridium. The iridium compound is dissolved in water or an appropriate solvent and used, but a method usually used for stabilizing a solution of iridium compound, namely a method of adding a solution of halogenated hydrogen (e.g. hydrochloric acid, bromic acid and fluoric acid) or a method of adding a halogenated alkali (e.g., KCl, NaCl, KBr and NaBr) may be used. Other silver halide particles doped with iridium in advance may be added and dissolved in place of water soluble iridium when silver halide is prepared. The amount of iridium added is preferably in the range of from 1×10⁻⁸ to 1×10⁻³ mole, more preferably from 1×10⁻⁷ to 5×10⁻⁴ mole with respect to 1 mole of silver halide.

Furthermore, metal atoms (for example, [Fe(CN)₆]⁴⁻) that can be contained in silver halide particles used in the present invention, and the desalination and chemical sensitization of silver halide emulsions are described in Japanese Patent Application Publication No. 11-84574, paragraph Nos. 0046 to 0050; Japanese Patent Application Publication No. 11-65021, paragraph Nos. 0025 to 0031; and Japanese Patent Application Publication No. 11-119374, paragraph Nos. 0242 to 0250.

Various types of gelatin can be used as the gelatin contained in the light-sensitive silver halide emulsion used in the present invention. In order to maintain the dispersion of the light-sensitive silver halide emulsion in an organic-silver-salt-containing coating liquid, the use of a low-molecular-weight gelatin of a molecular weight of 500 to 60,000 is preferable. Although such a low-molecular-weight gelatin may be used when the particles are formed, or dispersed after desalination treatment, it is preferable to use when the particles are dispersed after desalination treatment.

As a sensitizing dye that can be used in the present invention, a sensitizing dye that can spectrally sensitize silver halide particles in a desired wave-length region when adsorbed on the silver halide particles, and that has a spectral sensitivity commensurate with the spectral properties of the exposing light source can be chosen advantageously. Sensitizing dyes and method for adding are described in Japanese Patent Application Publication No. 11-65021, paragraphs 0103 to 0109; a compound represented by general formula (II) in Japanese Patent Application Publication No. 10-186572; a dye represented by general formula (I) in Japanese Patent Application Publication No. 11-119374, paragraph 0106; U.S. Pat. No. 5,510,236; a dye described in Example 5 of U.S. Pat. No. 3,871,887; a dye disclosed in Japanese Patent Application Publication No. 2-96131 and No. 59-48753; European Patent Application Publication No. 0803764A1, page 19, line 38 to page 20, line 35; Japanese Patent Application Nos. 2000-86865, 2000-102560, and 2000-205399. These sensitizing dyes may be used alone, or may be used in combination of two or more dyes. In the present invention, the time for adding the sensitizing dye in the silver halide emulsion is preferably after the desalination step up to application, and more preferably after the desalination step and before starting chemical aging.

Although the quantity of the sensitizing dye in the present invention can be any desired quantity to meet the properties of sensitivity or fog, the quantity for 1 mole of the silver halide in the light-sensitive layer is preferably 10⁻⁶ mole to 1 mole, and more preferably 10⁻⁴ mole to 10⁻¹ mole.

It is preferable that the light-sensitive silver halide particles in the present invention are chemically sensitized by sulfur sensitization, selenium sensitization, or tellurium sensitization. Compounds preferably used in sulfur sensitization, selenium sensitization, and tellurium sensitization are well known to those skilled in the art, and include, for example, a compound described in Japanese Patent Application Publication No. 7-128768. Particularly in the present invention, tellurium sensitization is preferable, and the compounds described in Japanese Patent Application Publication No. 11-65021, paragraph 0030, and the compounds represented by general formulas (II), (III), and (IV) in Japanese Patent Application Publication No. 5-313284 are preferably used.

In the present invention, chemical sensitization can be performed at any time after the formation of particles and before application, and specifically, it can be performed after desalination and (1) before spectral sensitization, (2) at the same time of spectral sensitization, (3) after spectral sensitization, and (4) immediately before application. In particular, it is preferable that chemical sensitization is performed after spectral sensitization.

Although the quantity of sulfur, selenium, and tellurium sensitizers used in the present invention varies depending on silver halide particles used, or the conditions of chemical aging, the quantity for 1 mole of the silver halide is usually 10⁻⁸ mole to 10⁻² mole, and preferably 10⁻⁷ mole to 10⁻³ mole. Although the conditions of chemical sensitization in the present invention are not specifically limited, the pH is preferably 5 to 8, the pAg is preferably 6 to 11, and the temperature is preferably 40° C. to 95° C.

To the silver halide emulsion used in the present invention, a thiosulfonate compound may be added using the method disclosed in European Patent Application Publication No. 293,917.

The light-sensitive silver halide emulsion in the light-sensitive material used in the present invention can be used alone, or two or more light-sensitive silver halide emulsions (for example, of different average particle sizes, different halogen compositions, different crystal habits, or different conditions of chemical sensitization) can be used in combination. The use of a plurality of light-sensitive silver halides of different sensitivities can control the tone. These techniques are disclosed in Japanese Patent Application Publication Nos. 57-119341, 53-106125, 47-3929, 48-55730, 46-5187, 50-73627, and 57-150841. The difference in sensitivity of each emulsion is preferably 0.2 log E or more.

The quantity of the light-sensitive silver halide in terms of the quantity of coating silver for 1 m² of the light-sensitive material is preferably 0.03 g/m² to 0.6 g/m², more preferably 0.07 g/m² to 0.4 g/m², and most preferably 0.05 g/m² to 0.3 g/m². To 1 mole of the organic silver salt, the quantity of the light-sensitive silver halide is preferably 0.01 mole or more and 0.5 mole or less, and more preferably 0.02 mole or more and 0.3 mole or less.

The methods and conditions for mixing the light-sensitive silver halide and the organic silver salt separately prepared include a method for mixing the prepared silver halide particles and the organic silver salt using a high-speed agitator, a ball mill, a sand mill, a colloid mill, a vibrating mill, or a homogenizer; or a method for mixing the prepared light-sensitive silver halide in some timing during the preparation of the organic silver salt; however, the method is not limited to a specific method as long as the effect of the present invention is obviously obtained. Mixing two or more aqueous dispersions of organic silver salt and two or more aqueous dispersions of light-sensitive silver salt is a preferable method for controlling photographic properties.

Although the time for adding the silver halide in a coating liquid for image forming layers in the present invention is 180 minutes before application to immediately before application, preferably 60 minutes to 10 seconds before application, a method and a condition for mixing are not specifically limited as long as the effect of the present invention is obviously obtained. Specific mixing methods include a method of mixing in a tank wherein the average retention time calculated from the flow rate and the quantity to the coater is controlled to a desired time; or a method to use a static mixer described in N. Harnby, M. F. Edwards, and A. W. Nienow, “Liquid Mixing Techniques”, translated by Koji Takahashi, Nikkan Kogyo Shimbun (1989), Chapter 8.

The binder of an organic-silver-salt-containing layer of the present invention may be any polymer, and preferable binders are transparent or translucent, and are generally colorless. They include natural resins, polymers, and copolymers; synthetic resins, polymers, and copolymers; and other media forming films, for example, gelatins, rubbers, polyvinyl alcohols, hydroxyethyl cellulose, cellulose acetate, cellulose acetate butylate, polyvinyl pirrolidone, casein, starch, polyacrylate, polymethyl methacrylate, polyvinyl chloride, polymethacrylate, styrene-maleic anhydride copolymers, styrene-acrylonitrile copolymers, styrene-butadiene copolymers, polyvinyl acetal (for example, polyvinyl methylal and polyvinyl butylal), polyesters, polyurethane, phenoxy resins, polyvinylidene chloride, polyepoxide, polycarbonate, polyvinyl acetate, polyolefins, cellulose esters, and polyamides. The binders may also be formed by coating from water, organic solvents, or emulsions.

In the present invention, the performance is improved when the organic-silver-salt-containing layer is formed by coating with a coating liquid containing a solvent whose 30% by mass or more is water, and drying; furthermore, when the binder of the organic-silver-salt-containing layer is soluble or dispersible in a water-based solvent (aqueous solvent); and particularly when the binder is composed of a polymer latex having an equilibrium moisture content at 25° C. and 60% RH of 2% by mass or less. The most preferable aspect is prepared so that the ion conductivity becomes 2.5 mS/cm or below. The methods for preparing such an aspect include purification treatment of the synthesized polymer using a membrane having an isolating function.

The water-based solvent wherein the polymer is soluble or dispersible used herein is water, or the mixture of water and 70% by mass or less water-miscible organic solvent. Water-miscible organic solvents include, for example, alcohols, such as methyl alcohol, ethyl alcohol, and propyl alcohol; cellosolves, such as methyl cellosolve, ethyl cellosolve, and butyl cellosolve; ethyl acetate; and dimethyl formamide.

In the case of a system wherein the polymer is not thermodynamically dissolved, and is present in a so-called dispersed state, the term of a water-based solvent is used here.

The “equilibrium moisture content at 25° C. and 60% RH” is represented by the following equation using the mass of the polymer W1 in a humidity-controlled equilibrium under an atmosphere of 25° C. and 60% RH, and the mass of the polymer WO in the absolute dry condition at 25° C.

Equilibrium moisture content at 25° C. and 60% RH ={(W1−W0)/W0}×100 (% by mass) The definition and the measuring method of moisture content can be referred to, for example, Polymer Engineering Seminar 14, Methods for Testing Polymers (Society of Polymer Science, Japan, Chijin Shokan).

The equilibrium moisture content at 25° C. and 60% RH of the binder polymer of the present invention is preferably 2% by mass or less, more preferably 0.01% by mass or more and 1.5% by mass or less, and most preferably 0.02% by mass or more and 1% by mass or less.

In the present invention, a polymer that is dispersible in a water-based solvent is particularly preferable. Examples of dispersed states include a latex wherein fine particles of a hydrophobic polymer insoluble in water are dispersed, and a dispersion of polymer molecules in a molecular state or in a micelle state, both of which are preferable. The average particle diameter of the dispersed particles is preferably within a range between 1 nm and 50,000 nm, and more preferably within a range between 5 nm and 1,000 nm. The particle diameter distribution of the dispersed particles is not specifically limited, and the dispersed particles may have a wide particle diameter distribution or a monodisperse particle diameter distribution.

In the present invention, preferred aspects of polymers dispersible in water-based solvents include hydrophobic polymers, such as acrylic polymers, polyesters, rubber (for example, SBR resin), polyurethane, polyvinyl chloride, polyvinyl acetate, polyvinylidene chloride, and polyolefins. These polymers may be straight-chain polymers, branched polymers or cross-linked polymers; may be homopolymers wherein a single type of monomers are polymerized; or may be copolymers wherein two or more types of monomers are polymerized. The copolymers may be random copolymers, or may be block copolymers. The molecular weight (number average molecular weight) of these polymers is 5,000 to 1,000,000, preferably 10,000 to 200,000. If the molecular weight is too low, the mechanical strength of the emulsion layer is insufficient; and if the molecular weight is too high, the film forming capability becomes poor.

Specific examples of preferable latexes are listed below. The list shows material monomers, the unit of values in parentheses is % by mass, and molecular weights are number average molecular weights. In the case of poly-functional monomers, since the concept of molecular weight cannot be applied because they form cross-linked structures, they are described as “cross-linkable”, and the description of molecular weights is omitted. Tg denotes glass transition temperature.

P-1; -MMA (70)-EA (27)-MAA (3)-latex (molecular weight: 37,000)

P-2; -MMA (70)-2EHA (20)-St (5)-AA (5)-latex (molecular weight: 40,000)

P-3; -St (50)-Bu (47)-MAA (3)-latex (cross-linkable)

P-4; -St (68)-Bu (29)-AA (3)-latex (cross-linkable)

P-5; -St (71)-Bu (26)-AA (3)-latex (cross-linkable, Tg 24° C.)

P-6; -St (70)-Bu (27)-IA (3)-latex (cross-linkable)

P-7; -St (75)-Bu (24)-AA (1)-latex (cross-linkable)

P-8; -St (60)-Bu (35)-DVB (3)-MAA (2)-latex (cross-linkable)

P-9; -St (70)-Bu (25)-DVB (2)-AA (3)-latex (cross-linkable)

P-10; -VC (50)-MMA (20)-EA (20)-AN (5)-AA (3)-latex (molecular weight: 80,000)

P-11; -VDC (85)-MMA (5)-EA (5)-MAA (5)-latex (molecular weight: 67,000)

P-12; -Et (90)-MMA (10)-latex (molecular weight: 12,000)

P-13; -St (70)-2EHA (27)-AA (3)-latex (molecular weight: 130,000)

P-14; -MMA (63)-EA (35)-AA (2)-latex (molecular weight: 33,000)

P-15; -St (70.5)-Bu (26.5)-AA (3)-latex (cross-linkable, Tg 23° C.)

P-16; -St (69.5)-Bu (27.5)-AA (3)-latex (cross-linkable, Tg 20.5° C.)

Abbreviations in the above-described structures denote the following monomers: MMA: methyl methacrylate, EA: ethyl acrylate, MAA: methacrylic acid, 2EHA: 2-ethylhexyl acrylate, St: styrene, Bu: butadiene, AA: acrylic acid, DVB: divinyl benzene, VC: vinyl chloride, AN: acrylonitrile, VDC: vinylidene chloride, Et: ethylene, IA: itaconic acid.

The above-described polymer latexes are also sold in the market, and the following polymers are commercially available. Examples of acrylic polymers include Cevian A-4635, 4718, and 4601 (Daicel Chemical Industries) and Nipol Lx 811, 814, 821, 820, and 857 (ZEON Corporation); examples of polyesters include FINETEX ES 650, 611, 675, and 850 (bainippon Ink and Chemicals, Inc.) and WD-size and WMS (Eastman Chemical); examples of polyurethane include HYDRAN AP 10, 20, 30, and 40 (Dainippon Ink and Chemicals, Inc.); examples of rubbers include LACSTAR 7301K, 3307B, 4700H, and 7132C (Dainippon Ink and Chemicals, Inc.) and Nipol Lx 416, 410, 438C, and 2507 (ZEON Corporation); examples of polyvinyl chloride include G351 and G576 (ZEON Corporation); examples of polyvinylidene chloride include L502 and L513 (Asahi Kasei); and examples of polyolefins include Chemipearl S120 and SA100 (Mitsui Chemicals).

These polymer latexes may be used alone, or may be used in combination of two or more as required.

The polymer latex preferably used in the present invention is latex of a styrene-butadiene copolymer. The mass ratio of styrene monomer units to butadiene monomer units in the styrene-butadiene copolymer is preferably 40:60 to 95:5. The proportion of styrene monomer units and butadiene monomer units in the copolymer is preferably 60% by mass to 99% by mass. The preferable molecular weight range is the same as described above.

Latexes of styrene-butadiene copolymers preferably used in the present invention include the above-described P-3 to P-8, P-14, P-15, commercially available LACSTAR-3307B, 7132C, and Nipol Lx 416.

In the organic-silver-salt-containing layer of the light-sensitive material of the present invention, hydrophilic polymers, such as gelatin, polyvinyl alcohol, methylcellulose, hydroxypropyl cellulose, and carboxymethyl cellulose may be added as required. The content of these hydrophilic polymers in the total quantity of binders in the organic-silver-salt-containing layer is preferably 30% by mass or less, and more preferably 20% by mass or less.

The organic-silver-salt-containing layer (image forming layer) of the present invention is preferably formed from polymer latex. The mass ratio of the total quantity of the binder to the organic silver salt in the organic-silver-salt-containing layer is within a range between 1/10 and 10/1, preferably 1/5 and 4/1.

Such an organic-silver-salt-containing layer is normally a light-sensitive layer (emulsion layer) containing light-sensitive silver halide, which is a light-sensitive silver salt, and in this case, the mass ratio of total binders to the silver halide is within a range between 400 and 5, preferably 200 to 10.

The total quantity of the binder in the image-forming layer of the present invention is within a range between 0.2 g/m² and 30 g/m², preferably between 1 g/m² and 15 g/m². In the image-forming layer of the present invention, a cross-linking agent for cross-linking, and a surfactant for improving coating properties may be added.

In the present invention, the solvent (here, a solvent and a dispersant are collectively referred to as solvent for simplification) in the coating liquid for the organic-silver-salt-containing layer of the light-sensitive layer in the present invention is preferably a water-based solvent containing 30% by mass or more water. The components other than water may be any optional water-miscible organic solvents, such as methyl alcohol, ethyl alcohol, isopropyl alcohol, methyl cellosolve, ethyl cellosolve, dimethyl formamide and ethyl acetate. The water content in the solvent of the coating liquid is preferably 50% by mass or more, and more preferably 70% by mass or more. The preferable examples of solvent compositions are water, water/methyl alcohol=90/10, water/methyl alcohol=70/30, water/methyl alcohol/dimethyl formamide=80/15/5, water/methyl alcohol/ethyl cellosolve=85/10/5, and water/methyl alcohol/isopropyl alcohol=85/10/5 (unit: % by mass).

The anti-fog agent, stabilizer, and precursor for the stabilizer that can be used in the present invention include compounds described in Japanese Patent Application Publication No. 10-62899, paragraph 0070, European Patent Application Publication No. 0803764A1, page 20, line 57 to page 21, line 7, and Japanese Patent Application Publication Nos. 9-281637 and 9-329864. The anti-fog agents preferably used in the present invention are organic halogen compounds, and are disclosed in Japanese Patent Application Publication No. 11-65021, paragraphs 0111 to 0112. The organic halogen compounds represented by formula (P) of Japanese Patent Application No. 11-87297, the organic polyhalogen compound represented by general formula (II) of Japanese Patent Application Publication No. 10-339934, and the organic polyhalogen compounds described in Japanese Patent Application No. 11-205330 are particularly preferable.

In the present invention, the methods for containing an anti-fog agent in the light-sensitive material include the method described in the above-described method for containing the reducer, and the addition of fine solid particles is also preferable for the organic polyhalogen compound.

Other anti-fog agents include the mercury (II) salt in Japanese Patent Application Publication No. 11-65021, paragraph 0113, benzoates in Japanese Patent Application Publication No. 11-65021, paragraph 0114, salicylic acid derivatives in Japanese Patent Application Publication No. 2000-206642, formalin scavenger compounds represented by formula (S) in Japanese Patent Application Publication No. 2000-221634, triazine compounds according to claim 9 of Japanese Patent Application Publication No. 11-352624, the compounds represented by general formula (III) of Japanese Patent Application Publication No. 6-11791, and 4-hydroxy-6-methyl-1,3,3a,7-tetrazaindene.

The photothermographic material of the present invention may contain an azolium salt for the purpose of preventing fog. The azolium salts include the compounds represented by general formula (XI) described in Japanese Patent Application Publication No. 59-193447, the compound described in Japanese Patent publication No. 55-12581, and the compounds represented by general formula (II) described in Japanese Patent Application Publication No. 60-153039. Although the azolium salt can be added to any positions in the light-sensitive material, addition to the layer on the surface having the light-sensitive layer is preferable, and addition to the organic-silver-salt-containing layer is more preferable. Although the azolium salt can be added in any steps for the preparation of the coating liquid, and when it is added to the organic-silver-salt-containing layer, it can be added in any steps from the time for the preparation of the organic silver salt to the preparation of the coating liquid, and preferably the time after the preparation of the organic silver salt to immediately before coating. The azolium salt may be added in any forms, such as powder, a solution, and a dispersion of fine particles. It may also be added as a solution whereto other additives, such as a sensitizing dye, a reducer, and toning agent, are added. In the present invention, although the quantity of the azolium salt to be added may be optional, it is preferably 1×10⁻⁶ mole or more and 2 moles or less, and more preferably 1×10⁻³ mole or more and 0.5 moles or less to 1 mole of silver.

In the present invention, a mercapto compound, a disulfide compound, and a thion compound may be contained for inhibiting, accelerating, or controlling development; for improving the efficiency of spectral sensitization; and for improving storage stability before and after development. The specific examples are described in Japanese Patent Application Publication No. 10-62899, paragraphs 0067 to 0069; the compounds represented by general formula (I) of Japanese Patent Application Publication No. 10-186572, and paragraphs 0033 to 0052; European Patent Application Publication No. 0803764A1, page 20, lines 36 to 56; and Japanese Patent Application No. 11-273670. Above all, a mercapto-substituted heterocyclic aromatic compound is preferable.

In the present invention, a compound having a phosphoryl group is preferably used, and phosphine oxides are particularly preferable. Specifically, these compounds include triphenylphosphine oxide, tri-(4-methylphenyl) phosphine oxide, tri-(4-methoxyphenyl) phosphine oxide, tri-(t-butyl-phenyl) phosphine oxide, tri-(3-methylphenyl) phosphine oxide and trioctylphosophine oxide. The compound having a phosphoryl group of the present invention can be introduced in a sensitive material in the same way as the reducing agent and polyhalogen compound. The content of compound having a phosphoryl group of the present invention is preferably in the range of from 0.1 to 10, more preferably from 0.1 to 2.0 with respect to the ratio of added reducing agent (molar ratio). It is more preferably in the range of from 0.2 to 1.0.

In the photothermographic material of the present invention, the addition of a toning agent is preferable. Toning agents are described in Japanese Patent Application Publication No. 10-62899, paragraph Nos. 0054 and 0055; European Patent Application Publication No. 0803764A1, page 21, lines 23 to 48; Japanese Patent Application Publication No. 2000-356317; and Japanese Patent Application No. 2000-187298. Particularly preferable are phthaladinones (phthaladinone, phthaladinone derivatives, or metal salts; for example, 4-(1-naphthyl) phthaladinone, 6-chlorophthaladinone, 5,7-dimethoxyphthaladinone, and 2,3-dihydro-1,4-phthaladinedione); the combination of phthaladinones and phthalates (for example, phthalic acid, 4-methyl phthalic acid, 4-nitro phthalic acid, diammonium phthalate, sodium phthalate, potassium phthalate, and tetrachloro phtalic anhydride); phthaladines (phthaladine, phthaladine derivatives, or metal salts; for example, 4-(1-naphthyl) phthaladine, 6-isopropyl phthaladine, 6-t-butyl phthaladine, 6-chloro phthaladine, 5,7-dimethoxy phthaladine, and 2,3-dihydro phthaladine); and the combination of phthaladines and phthalates. Of these, the combination of phthaladines and phthalates is most preferable.

Plasticizers and lubricants that can be used in the light-sensitive layers of the present invention are described in Japanese Patent Application Publication No. 11-65021, paragraph 0117; the super-high contract agents for forming super-high contract images, and the method of addition and quantity thereof are described in Japanese Patent Application Publication No. 11-65021, paragraph 0118; Japanese Patent Application Publication No. 11-223898, paragraphs 0136 to 0193; Japanese Patent Application No. 11-87297, compounds of formulas (H), (1) to (3), (A), and (B); Japanese Patent Application No. 11-91652, compounds of general formulas (III) to (V) (specific compounds: compounds 21 to 24); and high-contrast promoters are described in Japanese Patent Application Publication No. 11-65021, paragraph 0102, and Japanese Patent Application Publication No. 11-223898, paragraphs 0194 and 0195.

In order to use formic acid or a formate as a strong fogging substance, it is preferably contained in the side having an image-forming layer that contains the light-sensitive silver halide in a quantity of 5mmol or less for 1 mole of silver, more preferably 1 mmol or less.

When an ultra-high contrast agent is used in the photothermographic material of the present invention, it is preferable to use in combination with an acid or the salt thereof formed by hydrating diphosphorus pentaoxide. The acids or the salts thereof formed by hydrating diphosphorus pentaoxide include metaphosphoric acid (metaphosphorates), pyrophosphoric acid (pyrophosphorates), orthophosphoric acid (orthophosphorates), triphosphoric acid (triphosphorates), tetraphosphoric acid (tetraphosphorates), and hexametaphosphoric acid (hexametaphosphorates). Particularly preferable acids or the salts thereof formed by hydrating diphosphorus pentaoxide are orthophosphoric acid (orthophosphorates), and hexametaphosphoric acid (hexametaphosphorates). Specific salts include sodium orthophosphorate, dihydrogen sodium orthophosphorate, sodium hexametaphosphorate, and ammonium hexametaphosphorate.

Although the quantity (coating quantity for 1 m² of the light-sensitive material) of acids or the salts thereof formed by hydrating diphosphorus pentaoxide may be as desired depending on the performance, such as sensitivity and fog, it is preferably 0.1 mg/m² to 500 mg/m², and more preferably 0.5 mg/m² to 100 mg/M².

The photothermographic material of the present invention may have a surface-protecting layer for the purpose of preventing the adherence of the image-forming layer. The surface-protecting layer may be of a single layer, or may be of multiple layers. The surface-protecting layer is described in Japanese Patent Application Publication No. 11-65021, paragraphs 0119 to 0120, and Japanese Patent Application No. 2000-171936.

Although gelatin is preferably used for the binder of the surface-protecting layer of the present invention, it is also preferable to use or to combine polyvinyl alcohol (PVA). Gelatin that can be used include inert gelatin (for example, Nitta Gelatin 750) and phthalated gelatin (for example, Nitta Gelatin 801). PVA that can be used is described in Japanese Patent Application Publication No. 2000-171936, paragraphs 0009 to 0020, and fully saponified PVA-105, partially saponified PVA-205, PVA-335, and modified polyvinyl alcohol MP-203 (KURARAY) are preferably used. The quantity of polyvinyl alcohol coating as the protecting layer (per layer) (per 1 m² of the support) is preferably 0.3 g/m² to 4.0 g/m², and more preferably 0.3 g/m² to 2.0 g/m².

Particularly, when the photothermographic material of the present invention is used for printing, wherein change in dimensions raises problems, the use of polymer latex in the surface-protecting layer or the backing layer is preferable. Such polymer latexes are described in Taira Okuda and Hiroshi Inagaki, “Synthetic Resin Emulsion”, Kobunshi Kankoukai (1978); Takaaki Sugimura, Yasuo Kataoka, Soichi Suzuki, and Keiji Kasahara, “Application of Polymer Latex”, Kobunshi Kankoukai (1993); and Soichi Muroi, “Chemistry of Polymer Latex”, Kobunshi Kankoukai (1970). Specifically, the polymer latexes include a latex of methyl methacrylate (33.5% by mass)/ethyt acrylate (50% by mass)/methacrylic acid (16.5% by mass) copolymer; a latex of methyl methacrylate (47.5% by mass)/butadiene (47.5% by mass)/itaconic acid (5% by mass) copolymer; a latex of ethyl acrylate/metacrylic acid copolymer; a latex of methyl methacrylate (58.9% by mass)/2-etylhexyl acrylate (25.4% by mass)/styrene (8.6% by mass)/2-hydroxyethyl methacrylate (5.1% by mass)/acrylic acid (2.0% by mass) copolymer; and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer. Furthermore, the combination of polymer latexes described in Japanese Patent Application No. 11-6872, the technique described in Japanese Patent Application No. 11-143058, paragraphs 0021 to 0025; the technique described in Japanese Patent Application No. 11-6872, paragraphs 0027 to 0028; and the technique described in Japanese Patent Application No. 10-199626, paragraphs 0023 to 0041 can be applied to binders for surface-protecting layer. The content of the polymer latex for surface-protecting layer is preferably 10% by mass to 90% by mass of the total binder, more preferably 20% by mass to 80% by mass.

The quantity of the total binders (including water-soluble polymers and latex polymers) of the surface-protecting layer (per layer) (per 1 m² of the support) is preferably 0.3 g/m² to 5.0 g/m², and more preferably 0.3 g/m² to 2.0 g/m².

The temperature in the preparation of the, coating liquid for the image-forming layer in the present invention is 30° C. or above and 65° C. or below, preferably 35° C. or above and below 60° C., and more preferably 35° C. or above and 55° C. or below. It is also preferable that the temperature of the coating liquid for the image-forming layer immediately after the addition of polymer latex is maintained at 30° C. or above and 65° C. or below.

The organic silver salt-containing fluid or thermal image forming layer coating liquid in the present invention is preferably so called a thixotropic fluid. The thixotropic characteristic refers to a nature such that viscosity is reduced as the sheering speed increases. Any apparatus may be used for measuring viscosity in the present invention, but RFS Fluid Spectrometer manufactured by Rheometric Far East Co., Ltd. is preferably used, and viscosity is measured at 25° C. The viscosity of the organic silver salt-containing fluid or thermal image forming layer coating liquid at the sheering speed of 0.1S⁻¹ in the present invention is preferably in the range of from 400 mPa·s to 100,000 mPa·s inclusive, more preferably from 500 mPa·s to 20,000 mPa·s inclusive. Also, the viscosity is preferably in the range of from 1 mPa·s to 200 mPa·s inclusive, further preferably from 5 mPa·s to 80 mPa·s inclusive at the sheering speed of 1000S⁻¹.

A various kinds of systems expressing the thixotropic characteristic are known, and they are described in “Course: Rheology” edited by Polymer Journal Press, “Polymer latex” (Polymer Journal Press) by Muroi and Morino in collaboration. The fluid should contain a large amount of solid fine particles for expressing the thixotropic characteristic. In addition, for enhancing the thixotropic characteristic, it can be achieved effectively by incorporating a viscosity improving linear polymer, increasing the aspect ratio with irregular shapes of contained solid fine particles, using an alkali viscosity improver and a surfactant, and so on.

The image-forming layer of the present invention is composed of one or more layer on the support. When it is composed of one layer, the layer comprises an organic silver salt, light-sensitive silver halide, a reducer, and a binder, and as required, contains additional materials, such as a toning agent, covering additives and other auxiliary agents. When it is composed of two or more layers, the first image-forming layer (normally the layer contacting the support) must contain an organic silver salt and light-sensitive silver halide, and the second image-forming layer or both layers must contain other several components. The constitution of a multicolor photothermographic material may contain the combination of these two layers for each color, and all the components may be contained in a single layer, as described in U.S. Pat. No. 4,708,928. In the case of a multi-dye multicolor photothermographic material, each emulsion layer is separated from each other and maintained by using a functional or non-functional barrier layer between each light-sensitive layer, as described in U.S. Pat. No. 4,460,681.

Various dyes or pigments (for example, C.I. Pigment Blue 60, C.I. Pigment Blue 64, and C.I. Pigment Blue 15:6) can be used in the light-sensitive layer of the present invention from the pint of view of improving color tone, preventing the occurrence of interference fringes in exposing a laser beam, and preventing irradiation. These are described in WO 98/36322, and Japanese Patent Application Publication Nos. 10-268465 and 11-338098.

In the photothermographic material of the present invention, an anti-halation layer can be provided on the side of light-sensitive layer remote from the light source.

A photothermographic material has generally non-light-sensitive layers in addition to a light-sensitive layer. Non-light-sensitive layers can be classified according to the location thereof into (1) a protecting layer provided on the light-sensitive layer (remote side from the support), (2) an intermediate layer provided between a plurality of light-sensitive layers or between the light-sensitive layer and the protecting layer, (3) a primer layer provided between the light-sensitive layer and the support, and (4) a backing layer provided on the side opposite to the light-sensitive layer. A filter layer is provided on the light-sensitive layer as the layer (1) or (2). The anti-halation layer is provided on the light-sensitive layer as the layer (3) or (4).

Anti-halation layers are described in, for example, Japanese Patent Application Publication No. 11-65021, paragraphs 0123 and 0124; Japanese Patent Application Publication Nos. 11-223898, 9-230531, 10-36695, 10-104779, 11-231457, 11-352625, and 11-352626.

The anti-halation layer contains an anti-halation dye having absorption in the exposure wavelength. When the exposure wavelength is in the infrared region, an infrared absorbing dye can be used, and in this case, the dye that has no absorption in the visible region is preferable.

If halation is prevented using a dye having absorption in the visible region, it is preferable that the color of the dye does not substantially remain after forming images, a means to vanish the color with the heat of thermal development is used, and in particular, a thermally achromatizing dye and a base precursor are added to a non-light-sensitive layer to function as an anti-halation layer. These techniques are described in Japanese Patent Application Publication No. 11-231457.

The quantity of the achromatizing dye is determined according to the use of the dye. In general, it is used in a quantity that the optical density (absorbance) measured by the objective wavelength exceeds 0.1. The optical density is preferably 0.2 to 2. The quantity of the dye for obtaining such an optical density is generally approximately 0.001 g/m² to 1 g/m².

When the dye is achromatized, the optical density after thermal development can be lowered to 0.1 or less. Two or more achromatizing dyes may be used in combination in a thermally achromatizing recording material or a photothermographic material. Similarly, two or more base precursors may be used in combination.

In thermal achromatizing using such achromatizing dyes and base precursors, the combination use of a substance that lowers the melting point by 3 degrees or more by mixing with a base precursor such as described in Japanese Patent Application Publication No. 11-352626 (for example, diphenylsulfone and 4-chloroprene (phenyl) sulfide) is preferable from the point of view of thermal achromatizing.

In the present invention, for the purpose of improving change by aging of the silver color tone and the images, a colorant having an absorption maximum at 300 nm to 450 nm can be added. Such a colorant is described, for example, in Japanese Patent Application Publication Nos. 62-210458, 63-104046, 63-103235, 63-208846, 63-306436, 63-314535, 01-61745, and Japanese Patent Application No. 11-276751. Such a colorant is normally added within a range between 0.1 mg/M² and 1 mg/M², and the layer for the addition of the colorant is preferably the back layer provided opposite to the light-sensitive layer.

The photothermographic material in the present invention is preferably a one-sided light-sensitive material having at least one light-sensitive layer containing a silver halide emulsion on one side of the support, and having a backing layer on the other side.

In the present invention, it is preferable to add a mat agent for improving conveying properties, and the mat agent is described in Japanese Patent Application Publication No. 11-65021, paragraphs 0126 to 0127. The quantity of the mat agent coating for 1 m² of the light-sensitive material is preferably 1 mg/m² to 400 mg/m², and more preferably 5 mg/m² to 300 mg/m².

Although any mat degree of the emulsion surface is optional unless stardust defects occur, the Peck flatness is preferably 30 seconds or more and 2,000 seconds or less, and more preferably 40 seconds or more and 1,500 seconds or less. The Peck flatness can be obtained in accordance with Japanese Industrial Standards (JIS) P8119, “Method for Testing Flatness of Paper and Cardboard Using Peck Tester”, and TAPIR Standard Method T479.

In the present invention, the Peck flatness for a mat degree of the backing layer is preferably 1,200 seconds or less and 10 seconds or more, more preferably 800 seconds or less and 20 seconds or more, and most preferably 500 seconds or less and 40 seconds or more.

In the present invention, the matting agent is preferably contained in the outermost surface layer of the light-sensitive layer or a layer that functions as the outermost surface layer, a layer close to the outer surface, or a layer that functions as the protecting layer.

The backing layer that can be applied to the present invention is described in Japanese Patent Application Publication No. 11-65021, paragraphs 0128 to 0130.

For the photothermographic material in the present invention, pH of the film surface before heat development processing is preferably 6.0 or lower, more preferably 5.5 or lower. The lower limit thereof is not particularly limited, but is considered as low as about 3. For adjustment of pH of the film surface, an organic acid such as a phthalic acid derivative, a non-volatile acid such as sulfuric acid and a volatile base such as ammonium are preferably used in the sense that pH of the film surface is reduced. Particularly, ammonium is preferable in achieving a low level of pH of the film surface because it is highly volatile and thus can be removed before a step of coating and heat development is carried out. Furthermore, the method of measuring pH of the film surface is described in the paragraph No. 0123 of Japanese Patent Application Publication No. 11-87297.

In the layers of the present invention, such as light-sensitive layer, the protecting layer, and the backing layer, a hardener can be used. Examples of hardeners include methods described in T. H. James, “The Theory of the Photographic Process, Fourth Edition”, Macmillan Publishing Co. Inc, (1977), pages 77 to 87; and chrome alum, 2,4-dichloro-6-hydroxy-s-triazine sodium salt, N,N-ethylene bis(vinylsulfone acetamide), and N,N-propylene bis(vinylsulfone acetamide); as well as multivalent metal ions described in page 78 of the same reference book; polyisocyanates described in U.S. Pat. No. 4,281,060 and Japanese Patent Application Publication No. 6-208193; epoxy compounds described in U.S. Pat. No. 4,791,042; and vinylsulfone-based compounds described in Japanese Patent Application Publication No. 62-89048 are preferably used.

The hardener is added in the form of a solution, and the time for adding the solution to the coating liquid for the protecting layer is 180 minutes before to immediately before coating, preferably 60 minutes to 10 seconds before coating. The methods and conditions for mixing are not specifically limited as long as the effect of the present invention is sufficiently achieved. Specific methods for mixing include a method of mixing in a tank wherein the average retention time calculated from the flow rate and the quantity to the coater is controlled to a desired time; or a method to use a static mixer described in N. Harnby, M. F. Edwards, and A. W. Nienow, “Liquid Mixing Techniques”, translated by Koji Takahashi, Nikkan Kogyo Shimbun (1989), Chapter 8.

The surfactants, the solvent, the support, the anti-static or conductive layer, and the method for obtaining color images that can be used in the present invention are disclosed in Japanese Patent Application Publication No. 11-65021, paragraph 0132, 0133, 0134, 0135, and 0136, respectively; and the lubricants are described in Japanese Patent Application Publication No. 11-84573, paragraphs 0061 to 0064, and Japanese Patent Application No. 11-106881, paragraphs 0049 to 0062.

For a transparent support, polyester, especially polyethylene terephthalate undergone heat treatment within a temperature range between 130° C. and 185° C. is preferably used for relieving internal strain remaining in the film during biaxial drawing, and eliminating thermal shrinkage strain occurring during thermal development. In the case of a photothermographic material, the transparent support may be colored with a blue dye (for example, dye-1 described in Japanese Patent Application Publication No. 8-240877), or may be not colored. It is preferable that the primer techniques of water-soluble polyester described in Japanese Patent Application Publication No. 11-84574, styrene-butadiene copolymer described in Japanese Patent Application Publication No. 10-186565, and vinylidene chloride copolymers described in Japanese Patent Application Publication No. 2000-39684 and Japanese Patent Application No. 11-106881, paragraphs 0063 to 0080 are applied to the support. To the antistatic layers or the primers, the techniques described in Japanese Patent Application Publication Nos. 56-143430, 56-143431, 58-62646, 56-120519, and 11-84573, paragraphs 0040 to 0051, U.S. Pat. No. 5,575,957, and Japanese Patent Application Publication No. 11-223898, paragraphs 0078 to 0084 can be applied.

The photothermographic material is preferably of a monosheet type (a type that can form images on a photothermographic material not using other sheets as in image-receiving materials).

To the photothermographic material, an anti-oxidant, a stabilizer, a plasticizer, an ultraviolet absorber, or coating additives may further be added. The various additives are added to either the light-sensitive layer or a non-light-sensitive layer. These are described in WO 98/36322, EP 803764A1, Japanese Patent Application Publication Nos. 10-186567 and 10-18568.

The photothermographic material in the present invention can be applied using any methods. Specifically, various coating operations can be used, including extrusion coating, slide coating, curtain coating, dip coating, knife coating, flow coating, and extrusion coating using a hopper of a type described in U.S. Pat. No. 2,681,294. Extrusion coating described in Stephen F. Kistler, Petert M. Schweizer, “Liquid Film Coating”, (Chapman & Hall, 1997), pages 399 to 536, or slide coating are preferably used, and slide coating is most preferably used. An example of a form of slide coaters used for slide coating is shown in FIG. 11b.1 in page 427 of the above-described reference. If desired, two or more layers can be applied simultaneously using the methods described in pages 399 to 536 of the above-described reference, U.S. Pat. No. 2,761,791, and British Patent No. 837,095.

Techniques that can be used in the photothermographic material of the present invention are also described in EP 803764A1, EP 883022A1, WO 98/36322, Japanese Patent Application Publication Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569, 10-186570, 10-186571, 10-186572, 10-197974, 10-197982, 10-197983, 10-197985, 10-197986, 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536, 11-133537, 11-133538, 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, Japanese Patent Application Nos. 2000-187298, 2000-10229, 2000-47345, 2000-206642, 2000-98530, 2000-98531, 2000-112059, 2000-112060, 2000-112104, 2000-112064, 2000-171936, and 11-282190.

The photothermographic material of the present invention may be developed using any methods, and normally, it is developed by heating the photothermographic material exposed image-wise. The developing temperature is preferably 80° C. to 250° C., and more preferably 100° C. to 140° C. The developing time is preferably 1 second to 180 seconds, more preferably 10 seconds to 90 seconds, and most preferably 10 seconds to 40 seconds.

The preferable system for thermal development is a plate-heater system. The preferable thermal development system by a plate-heater system is a system described in Japanese Patent Application Publication No. 11-133572, which is a thermal development system for obtaining visible images by contacting a photothermographic material wherein a latent image has been formed with a heating means in the thermal development section. The thermal development system is characterized in that the heating means comprises a plate heater, a plurality of presser rollers are disposed facing and along a surface of the plate heater, and the photothermographic material is passed between the presser rollers and the plate heater to perform thermal development. It is preferable that the plate heater is divided into two to six stages, and that the temperature of the end portion is lowered by 1 to 10° C. Such a method, also described in Japanese Patent Application Publication No. 54-30032, can exclude moisture or organic solvents contained in the photothermographic material out of the system, and the deformation of the support of the photothermographic material suddenly heated can be prevented.

Although the light-sensitive material of the present invention can be exposed using any methods, a preferable light source for exposure is laser beams. The preferable laser beams for the present invention include gas laser (Ar⁺, He—Ne), YAG laser, dye laser, and semiconductor laser. A semiconductor laser and a second higher-harmonic-generating element can also be used. Red to infrared emitting gas or a semiconductor laser is preferable.

Laser imagers for medical use having an exposure section and a thermal development section include Fuji Medical Dry Laser Imager FM-DP L. The FM-DP L is described in Fuji Medical Review No. 8, pages 39 to 55, and these techniques can be applied to the laser imager of the photothermographic material of the present invention. These techniques can also be applied to the photothermographic material for the laser imager in “AD network” proposed by Fuji Medical System as a network system meeting the DICOM Standards.

The photothermographic material of the present invention forms black-and-white images by silver images, and is preferably used in the photothermographic material for medical diagnostics, the photothermographic material for industrial photography, the photothermographic material for printing, and the photothermographic material for COM.

(Fabrication of PET Support)

Using terephthalic acid and ethylene glycol, PET having an intrinsic viscosity (IV) of 0.66 (measured in a mixed solvent of phenol and tetrachloroethane (6:4 by mass) at 25° C.) was obtained according to a normal method. This was palletized, dried at 130° C. for 4 hours, melted at 300° C., extruded through a T-die, and quenched to form a non-oriented film of a thickness after heat fixing of 175 μm.

This film was longitudinally stretched 3.3 times using rolls of different circumferential speed, and transversally stretched 4.5 times using a tenter. The temperatures for stretching were 110° C. and 130° C., respectively. Thereafter, the film was heat-fixed at 240° C. for 20 seconds, and relaxed by 4% in the transverse direction at the same temperature. Then, the portion of the film held by the chuck of the tenter was cut off, the both edges were knurled, the film was wound at 4 kg/cm² to obtain a roll of the film having a thickness of 175 μm.

(Corona Treatment of Surface)

The both surfaces of the support were treated using a 6-kVA solid-state corona treatment system of Piller Inc. at room temperature at 20 m/min. From the readings of current and voltage, it was known that the support was treated at 0.375 kV·A·min/m². The treatment frequency was 9.6 kHz, and the gap clearance between the electrode and the dielectric roller was 1.6 mm.

(Fabrication of Primer Coating Support)

(1) Preparation of primer coating liquid

Formulation (for Primer-coating Layer in the Light-sensitive Layer Side)

| | | |
|---|---|---|
| Pesresin A-515GB (30% by mass solution) | 234 | g |
| (Takamatsu Oil & Fat) | | |
| Polyethylene glycol monononyl phenyl ether | 21.5 | g |
| (average ethylene oxide number = 8.5) | | |
| (10% by mass solution) | | |
| MP-1000 (Soken Chemical & Engineering) | 0.91 | g |
| (polymer fine particles, average particle diameter: | | |
| 0.4 μm) | | |
| Distilled water | 744 | mL |

Formulation (for First Layer in Back Surface)

| | |
|---|---|
| Styrene-butadiene copolymer latex | 158 g |
| (solid content: 40% by mass, styrene/butadiene mass | |
| ratio: 68/32) | |
| 2,4-dichloro-6-hydroxy-S-triazine, sodium salt | 20 g |
| (8% by mass aqueous solution) | |
| Sodium laurylbenzenesulfonate (1% by mass aqueous solution) | 10 mL |
| Distilled water | 854 mL |

Formulation (for Second Layer in Back Surface)

| | | |
|---|---|---|
| SnO₂/SbO | 84 | g |
| (9/1 mass ratio, average particle diameter: | | |
| 0.038 μm, 17 mass % dispersion) | | |
| Gelatin (10% by mass aqueous solution) | 89.2 | g |
| Metolose TC-5 (2% by mass aqueous solution) | 8.6 | g |
| (Shin-Etsu Chemical) | | |
| MP-1000 (Soken Chemical & Engineering) | 0.01 | g |
| Sodium dodecylbenzene sulfonate | 10 | mL |
| (1% by mass aqueous solution) | | |
| NaOH (1% by mass) | 6 | mL |
| Prokicell (ICI) | 1 | mL |
| Distilled water | 805 | mL |

(Fabrication of Primer Coated Support)

After the both surfaces of the above-described biaxially oriented polyethylene terephthalate support having a thickness of 175 μm was subjected to the above-described corona discharge treatment, one surface (light-sensitive layer side) was coated with the primer coating liquid of the above-described formulation with a wire bar so that the wet coating quantity became 6.6 mL/m² (per surface), and dried at 180° C. for 5 minutes. Then, the other surface (back face) was coated with the primer coating liquid of above-described formulation with a wire bar so that the wet coating quantity became 5.7 mL/m², and dried at 180° C. for 5 minutes. Furthermore, the other surface (back face) was coated with the primer coating liquid of above-described formulation with a wire bar so that the wet coating quantity became 7.7 mL/m², and dried at 180° C. for 6 minutes to fabricate a primer coated support.

(Preparation of Back Surface Coating liquid)

(Preparation of Solid Fine Particle Dispersion of Base Precursor (a))

64 g of base precursor compound 11, 28 g of diphenylsulfone and 10 g of surfactant Demor N manufactured by Kao Corp. were mixed with 220 ml of distilled water, and the mixture was bead-dispersed using a sand mill (¼ Gallon Sand Grinder Mill manufactured by IMEX Co., Ltd.) to obtain a solid fine particle dispersion base precursor compound (a) having an average particle size of 0.2 μm.

(Preparation of Dye Solid Fine Particle Dispersion)

9.6 g of cyanine dye compound 13 and 5.8 g of sodium P-dodecylbenzenesulfonate were mixed with 305 ml of distilled water, and the mixture was bead-dispersed using a sand mill (¼ Gallon Sand Grinder Mill manufactured by IMEX Co., Ltd.) to obtain a dye solid fine particle dispersion having an average particle size of 0.2 μm.

(Preparation of Antihalation Layer Coating liquid)

17 g of gelatin, 9.6 g of polyacrylamide, 70 g of solid fine particle dispersion base precursor compound (a) described above, 56 g of dye solid fine particle dispersion described above, 1.5 g of polymethyl methacrylate fine particles (average particle size of 6.5 μm), 0.03 g of benzoisothiazolinone, 2.2 g of sodium polyethylenesulfonate, 0.2 g of blue dye compound 14, 3.9 g of yellow dye compound 15 and 844 ml of water were mixed together to prepare an antihalation layer coating liquid.

(Preparation of Back Face Protecting Layer)

50 g of gelatin, 0.2 g of sodium polystyrenesulfonate, 2.4 g of N,N-ethylenebis (vinylsulfoneacetoamide), 1 g of sodium t-octylphenoxyethoxyethanesulfonate, 30 mg of benzoisothiazolinone, 37 mg of N-perfluorooctylsulfonyl-N-propylalanine potassium salt, 0.15 g of polyethyleneglycolmono (N-perfluorooctylsulfonyl-N-propyl-2-aminoethyl) ether (average polymerization degree of ethylene oxide: 15), 32 mg of C₈F₁₇SO₃K, 64 mg of C₈F₁₇SO₂N(C₃H₇)(CH₂CH₂O)₄(CH₂)₄-SO₃Na, 8.8 g of acrylic acid copolymer (weight ratio of copolymer: 5/95), 0.6 g of aerosol OT (manufactured by American Thianamide Co., Ltd.), 1.8 g of liquid paraffin emulsion as a liquid paraffin and 950 ml of water were mixed together with the container kept at 40° C. to prepare a back face protecting layer.

<Preparation of Silver Halide Emulsion 1>

A solution prepared by adding 3.1 ml of 1 wt % potassium bromide solution to 1421 ml of distilled water and then adding thereto 3.5 ml of 1 mol/L sulfuric acid and 31.7 g of phtalated gelatin was kept at 34° C. while it was stirred in a stainless reaction jar coated with titanium, and a solution A prepared by adding distilled water to 22.22 g of silver nitrite so that it was diluted to 95.4 ml and a solution B prepared by diluting 15.9 g of potassium bromide to 97.4 ml with distilled water were fully added thereto at a fixed flow rate for 45 seconds. Thereafter, 10 ml of 3.5 wt % hydrogen peroxide aqueous solution was added, and then 10.8 ml of 10 wt % benzoimidazole aqueous solution was added. Then, a solution C prepared by adding distilled water to 51.86 g of silver nitrate so that it was diluted to 317.5 ml was fully added at a fixed flow rate for 20 minutes, while a solution D prepared by diluting 45.8 g of potassium bromide to 400 ml with distilled water was added by a control double jet method while keeping pAg at 8.1. Potassium iridium (III) hexachloride was fully added so that its concentration was 1×10⁻⁴ mole with respect to 1 mole of silver 10 minutes after the solutions C and D started being added. In addition, an aqueous solution of potassium iron (II) hexacyanide was fully added in the amount of 3×10⁻⁴ mole with respect to 1 mole of silver 5 seconds after the addition of the solution C was completed. pH is adjusted to 3.8 using 0.5 mol/L sulfuric acid, stirring was stopped, and precipitation, desalination and rinsing steps were carried out. pH was adjusted to 5.9 using 1 mol/L sodium hydroxide to prepare a silver halide dispersion with pAg of 8.0.

The silver halide dispersion was kept at 38° C. while it was stirred, and 5 ml of 0.34 wt % methanol solution of 1,2-benzoisothiazoline-3-on was added, and after 40 minutes a methanol solution of spectrum sensitizing pigment A was added in the amount of 1×10⁻³ mole with respect to 1 mole of silver, and after 1 minute the mixture was heated to 47° C. 20 minutes after the temperature was raised, sodium benzenethiosulfonate was added with a methanol solution in the amount of 7.6×10⁻⁵ mole with respect to 1 mole of silver, and after 5 minutes a tellurium sensitizer B was added with a methanol solution in the amount of 1.9×10⁻⁴ mole with respect to 1 mole of silver, and was left for aging for 91 minutes. 1.3 ml of 0.8 wt % methanol solution of N,N′-dihydroxy-N″-diethylmelamine was added, and after 4 minutes 5-methyl-2-mercaptobenzoimidazole was added with a methanol solution in the amount of 3.7×10⁻³ mole with respect to 1 mole of silver and 1-phenyl-2-heptyl-5-mercapto-1,3,4-triazole was added with a methanol solution in the amount of 4.9×10⁻³ mole with respect to 1 mole of silver to prepare a silver halide emulsion 1.

Particles in the prepared silver halide emulsion were pure silver bromide particles having a ball-equivalent average size of 0.046 μm and a bail-equivalent coefficient of size variation of 20%. The particle size and the like were determined from the average size of 1000 particles using an electron microscope. The {100} plane ratio of the particles was determined to be 80% using the Kubelka-Munk method.

<Preparation of Silver Halide Emulsion 2>

A silver halide emulsion 2 was prepared in the same manner as preparation of the silver halide emulsion 1 except that the liquid temperature during formation of particles was changed from 34° C. to 49° C., the solution C was added for 30 minutes, and potassium iron (II) hexacyanide was removed. Precipitation, desalination, rinsing and dispersion processes were carried out in the same manner as preparation of the silver halide emulsion 1. Spectral sensitization and chemical sensitization are carried out, and 5-methyl-2-mercaptobenzoimidazole and 1-phenyl-2-heptyl-5-mercapto-1,3,4-triazole are added in the same manner as preparation of the emulsion 1 to obtain the silver halide emulsion 2 except that the amount of spectrum sensitizing pigment A added was changed to 7.5×10⁻⁴ mole with respect to 1 mole of silver, the amount of tellurium sensitizer B added was changed to 1×10⁻⁴ mole with respect to 1 mole of silver, and the amount of 1-phenyl-2-heptyl-5-mercapto-1,3,4-triazole was changed to 3.3×10⁻⁴ mole with respect to 1 mole of silver. Emulsion particles of the silver halide emulsion 2 were pure silver bromide cubic particles having a ball-equivalent average size of 0.080 μm and a ball-equivalent coefficient of size variation of 20%.

<Preparation of Silver Halide Emulsion 3>

A silver halide emulsion 3 was prepared in the same manner as preparation of the silver halide emulsion 1 except that the liquid temperature during formation of particles was changed from 34° C. to 27° C. In addition, precipitation, desalination, rinsing and dispersion processes were carried out in the same manner as preparation of the silver halide emulsion 1. The silver halide emulsion 3 was obtained in the same manner as the emulsion 1 except that the amount of added solid dispersion of spectrum sensitizing pigment A (gelatin aqueous solution) was changed to 6×10⁻³ mole with respect to 1 mole of silver, and the amount of tellurium sensitizer B added was changed to 5.2×10⁻⁴ mole with respect to 1 mole of silver. Emulsion particles of the silver halide emulsion 3 were pure silver bromide cubic particles having a ball-equivalent average size of 0.038 μm and a ball-equivalent coefficient of size variation of 20%.

<Preparation of mixed emulsion A for Coating liquid>

70% by weight of silver halide emulsion 1, 15% by weight of silver halide emulsion 2 and 15% by weight of silver halide emulsion 3 were dissolved, and 1 wt % aqueous solution of berizothiazoriumiodide was added in the amount of 7×10⁻³ mole with respect to 1 mole of silver.

<Preparation of Flake-Shaped Aliphatic Silver Salt>

87.6 kg of behenic acid manufactured by Henkel Co., Ltd. (trade name: Edenor C22-85R), 423 L of distilled water, 49.2 L of 5N-NaOH aqueous solution and 120 L of tert-butanol were mixed together, and were stirred and made to react at 75° C. for 1 hour to obtain a sodium behanate solution. On the other hand, 206.2L of aqueous solution of 40.4 kg of silver nitrate (pH 4.0) was prepared and kept at a temperature of 10° C. A reaction container containing 635 L of distilled water and 30 L of tert-butanol was kept at a temperature of 30° C., and a total amount of the above described sodium behanate solution and a total amount of silver nitrate aqueous solution were added thereto at a fixed flow rate for 62 minutes and 10 seconds and 60 minutes, respectively while stirring. At this time, only the silver nitrate aqueous solution was added for 7 minutes and 20 seconds after the addition of the silver nitrate aqueous solution was started, and thereafter the addition of the sodium behenate solution was started, and only the sodium behenate solution was added for 9 minutes and 30 seconds after the addition of the silver nitrate aqueous solution was completed. At this time, the temperature in the reaction container was 30° C., and the external temperature was controlled so that the liquid temperature was kept constant. In addition, the pipe of the feeding system of the sodium behenate solution was thermally insulated by a steam trace, and the steam aperture was adjusted so that the temperature of liquid at the outlet of the edge of a feeding nozzle was kept at 75° C. In addition, the pipe of the feeding system of the silver nitrate aqueous solution was thermally insulated by circulating chilled water through the outer line of a duplex tube. The position at which the sodium behenate solution was added and the position at which the silver nitrate aqueous solution was added were symmetrical with respect to the mixing axis, and their heights were adjusted so that the solutions did not contact a reaction solution.

The sodium behenate solution was completely added, and was thereafter stirred and left at the same temperature for twenty minutes, and then the temperature was decreased to 25° C. Thereafter, the solid matter was filtered out by centrifugal filtration, and the solid matter was rinsed until the conductivity of the filtrate was 100 μS/cm. In this way, an aliphatic silver salt was obtained. The obtained solid matter was stored as a wet cake without being dried.

The morphology of the obtained behenic acid particles was examined by electron photornicrography, and it was found that the behenic acid particle was a flake-shaped crystal having values of a=0.14 μm, b=0.4 μm and c=0.6 μm, an average aspect ratio of 5.2, a ball-equivalent average diameter of 0.52 μm and a ball-equivalent coefficient of variation of 15% (a, b and c are herein defined).

7.4 g of polyvinyl alcohol (trade name: PVA-217) and water were added to the wet cake equivalent to 100 g of dried solid matter so that the total weight thereof was 385 g, and then the wet cake was subjected to preliminary dispersion processing by a homomixer.

Then, the stock solution subjected to the preliminary dispersion processing was treated three times by a dispersing apparatus (trade name: Micro Fluidizer-M-110S-EH manufactured by Microfluidex International Corporation, using a G10Z interaction chamber) adjusted so that the pressure thereof was kept at 1750 kg/cm², whereby a behenic acid silver dispersion was obtained. For cooling operation, hose-type heat exchangers were each installed before and after the interaction chamber, the temperature of a coolant was adjusted to set the dispersing temperature at 18° C.

<Preparation of 25 wt % Reducing Agent Dispersion>

16 kg of water was added to 10 kg of 1,1-bis (2-hydroxy-3,5-dimethylphenyl)-3,5,5-trimethylhexane and 10 kg of 20 wt % aqueous solution of denatured polyvinyl alcohol (Poval MP203 manufactured by Kuraray Co., Ltd.), and was sufficiently mixed to prepare a slurry. This slurry was delivered by a diaphragm pump, and was dispersed for 3 hours and 30 minutes by a lateral sand mill (UVM-2 manufactured by IMEX Co., Ltd.) filled with zirconium beads with the average diameter of 0.5 mm, and thereafter 0.2 g of sodium benzoisothiazoriunon and water were added thereto to make an adjustment so that the concentration of the reducing agent was 25 wt %, whereby a reducing agent dispersion was obtained. Reducing agent particles contained in the reducing agent dispersion obtained in this way had a median diameter of 0.42 μm and the maximum particle size of 2.0 μm or smaller. The obtained reducing agent dispersion was filtered by a polypropylene filter with the pore size of 10 μm to remove foreign materials, and was then stored.

<Preparation of 10 wt % Mercapto Compound Dispersion>

8.3 kg of water was added to 5 kg of 1-phenyl-2-heptyl-5-mercapto-1,3,4-triazole and 5 kg of 20 wt % aqueous solution of denatured polyvinyl alcohol (Poval MP203 manufactured by Kuraray Co., Ltd.), and was sufficiently mixed to prepare a slurry. This slurry was delivered by a diaphragm pump, and was dispersed for 6 hours by a lateral sand mill (UVM-2 manufactured by IMEX Co., Ltd.) filled with zirconium beads with the average diameter of 0.5 mm, and thereafter water was added thereto to make an adjustment so that the concentration of the mercapto compound was 10 wt %, whereby a mercapto dispersion was obtained. Mercapto compound particles contained in the mercapto compound dispersion obtained in this way had a median diameter of 0.40 μm and the maximum particle size of 2.0 μm or smaller. The obtained mercapto compound dispersion was filtered by a polypropylene filter with the pore size of 10 μm to remove foreign materials, and was then stored. In addition, it was filtered again by the polypropylene filter with the pore size of 10 μm immediately before it was used.

<Preparation of 20 wt % Organic Polyhalogen Compound Dispersion-1>

5 kg of tribromomethylnaphthylsulfone, 2.5 kg of 20 wt % aqueous solution of denatured polyvinyl alcohol (Poval MP203 manufactured by Kuraray Co., Ltd.), 213 g of 20 wt % aqueous solution of sodium triisopropylnaphthalenesulfonate and 10 kg of water were added and mixed sufficiently to prepare a slurry. This slurry was delivered by a diaphragm pump, and was dispersed for 5 hours by a lateral sand mill (UVM-2 manufactured by IMEX Co., Ltd.) filled with zirconium beads with the average diameter of 0.5 mm, and thereafter 0.2 g of sodium benzoisothiazoriunon and water were added thereto to make an adjustment so that the concentration of the organic polyhalogen compound was 20 wt %, whereby an organic polyhalogen compound dispersion was obtained. Organic polyhalogen compound particles contained in the polyhalogen compound dispersion obtained in this way had a median diameter of 0.36 μm and the maximum particle size of 2.0 μm or smaller. The obtained reducing agent dispersion was filtered by a polypropylene filter with the pore size of 3.0 μm to remove foreign materials, and was then stored.

<Preparation of 25 wt % Organic Polyhalogen Compound Dispersion-2>

An organic polyhalogen compound was prepared in the same manner as preparation of the 20 wt % organic polyhalogen compound dispersion-1 except that 5 kg of tribromomethyl (4-(2,4,6-trimethylphenylsulfonyl) phenyl) sulfone was used instead of 5 kg of tribromomethylnaphthylsulfone, and was dispersed and diluted so that the concentration of the organic polyhalogen compound was 25 wt %, and was filtered. Organic polyhalogen compound particles contained in the organic polyhalogen compound dispersion obtained in this way had a median diameter of 0.38 μm and the maximum particle size of 2.0 μm or smaller. The obtained reducing agent dispersion was filtered by a polypropylene filter with the pore size of 3.0 μm to remove foreign materials, and was then stored.

<Preparation of 30 wt % Organic Polyhalogen Compound Dispersion-3>

An organic polyhaiogen compound was prepared in the same manner as preparation of the 20 wt % organic polyhalogen compound dispersion-1 except that 5 kg of tribromophenylsulfone was used instead of 5 kg of tribromomethylnaphthylsulfone and the amount of 20 wt % MP203 aqueous solution was changed to 5 kg, and was dispersed and diluted so that the concentration of the organic polyhalogen compound was 30 wt %, and was filtered. Organic polyhalogen compound particles contained in the organic polyhalogen compound dispersion obtained in this way had a median diameter of 0.41 μm and the maximum particle size of 2.0 μm or smaller. The obtained reducing agent dispersion was filtered by a polypropylene filter with the pore size of 3.0 μm to remove foreign materials, and was then stored. Thereafter it was stored at a temperature of 10° C. or lower until it was used.

<Preparation of 5 wt % Solution of Phthalazine Compound>

8 kg of denatured polyvinyl alcohol MP203 manufactured by Kuraray Co., Ltd. was dissolved in 174.57 Kg of water, and then 3.15 Kg of 20 wt % aqueous solution of sodium triisopropylnaphthalenesulfonate and 14.28 Kg of 70 wt % aqueous solution of 6-isopropylphthalazine were added thereto to prepare 5 wt % solution of 6-isopropylphthalazine.

<Preparation of 20 wt % Pigment Dispersion>

250 g of water was added to 64 g of C.I. Pigment Blue 60 and 6.4 g of Demor N manufactured by Kao Corp., and was sufficiently mixed to prepare a slurry. 800 g of zirconium beads with the average diameter of 0.5 mm were prepared, and put in a vessel together with the slurry, and were dispersed for 25 hours by a dispersing apparatus (¼ G Sand Grainder Mill manufactured by IMEX Co., Ltd.) to obtain a pigment dispersion. Pigment particles contained in the pigment dispersion obtained in this way had an average particle size of 0.21 μm.

<Preparation of 40 wt % SBR latex>

An SBR latex purified by ultrafiltration (UF) was obtained in the following manner.

A solution prepared by diluting the SBR latex described below to ten parts with distilled water was diluted and purified until the ion conductivity reached 1.5 mS/cm using a UF-purifying module FS03-FC-FUY03A1 (manufactured by Daisen Membrane System Co., Ltd.), and Sandet-BL manufactured by Sanyo Chemical Co., Ltd. was added so that the concentration thereof was 0.22 wt %. Further, NaOH and NH₄OH were added so that the ratio between Na⁺ ion and the NH₄⁺ ion was Na⁺ ion : NH₄⁺ ion=1: 2.3 (molar ratio) to make an adjustment so that the pH was kept at 8.4. The concentration of latex at this time was 40 wt %.

(SBR Latex: Latex of -St(68)-Bu(29)-AA(3)-)

<Preparation of Emulsion Layer (Photosensitive Layer) Coating liquid>

First, 5.5 kg of the 20 wt % pigment aqueous dispersion was delivered into the agitation tank of the preparation and deaeration apparatus, and thereafter 515 kg of organic acid silver dispersion was added with the position of the outlet of the delivery pipe in the agitation tank set at a location about 3 cm below than the surface of the first delivered pigment aqueous dispersion. Subsequently, 25 kg of 20 wt % aqueous solution of polyvinyl alcohol PVA-205 (manufactured by Kuraray Co., Ltd.), 125 kg of 25 wt % reducing agent dispersion described above, total 81.5 kg of organic polyhalogen compound dispersions-1,-2 and -3 in the ratio of 5:1:3 (weight ratio), 31 kg of 10% mercapto compound dispersion, 530 kg of 40 wt % SBR latex subjected to ultrafiltration (UF) and pH adjustment, and 90 L of 5 wt % solution of butadiene compound were each added to prepare a mother liquid of coating liquid. In this case, the position of the outlet of the delivery pipe in the constituent liquid of coating liquid of 20 wt % aqueous solution of polyvinyl alcohol PVA-205 (manufactured by Kuraray Co., Ltd.) was slid so that it was located about 20 cm below the liquid surface. A tank having an inner diameter of 160 cm was used as the agitation tank, and a turbine blade having a diameter of 40 cm was used as the mixing blade. The agitation tank had a jacket, and the temperature in the tank was kept at 35° C. by circulating thermal insulation water. After all constituent liquids of coating liquid were delivered into the agitation tank, the pressure in the agitation tank was reduced to 30 kPa of absolute pressure, and the liquids were stirred and mixed by the turbine blade with the rotation speed of 100 rpm for 180 minutes.

Then, immediately before the mixing container in the inflow pipe through which the mother liquid of coating liquid was delivered to the inline mixer, 50 kg of silver halide mixture emulsion A was delivered and added from the feeding line, and was mixed in the inline mixer to prepare an emulsion layer coating liquid.

### EXAMPLES

Examples of producing photothermographic materials using the photothermographic material producing apparatus of the present invention will now be described.

Several types of coating solutions including coating solutions prepared according to the above-described “preparation of emulsion layer (photosensitive layer) coating solution” were simultaneously applied in stratification at the coating speed of 120 m/minute using a slide bead coating device as a coating device.

The coating film formed with the coating device was cooled by blowing air with the dry-bulb temperature of 15° C. and the wet-bulb temperature of 6° C. against the coating film at the average wind speed of 3 m/second for 20 seconds in the chilling device, followed by drying the coating film by blowing dry air with the dry-bulb temperature of 35° C. and the wet-bulb temperature of 19° C. against the coating film at the wind speed of 20 m/second for 250 seconds in the parallel type noncontact drying device. After about 10 seconds, the substrate was transported into the thermal treatment device to thermally treat the coating film. In the heating zone of the thermal treatment device, the surface temperature of the coating film was increased to the thermal treatment temperature by heating with hot air blown off from the nozzle at the wind speed of 25 m/second, and the surface temperature was kept at the thermal treatment temperature by the atmosphere heating with air breeze at the wind speed of 3 m/second in the thermal retaining zone. Subsequently, the coating film was cooled by blowing off cold air with the dry-bulb temperature of 20° C. and the relative humidity of 70% from the nozzles at the wind speed of 25 m/second for 3 seconds to decrease the surface temperature of the coating film to near a room temperature, followed by winding up the substrate by the winding device. Furthermore, the residence time in each zone was changed by changing the path length of the substrate.

In the above-described thermal treatment, evaluations were made on photographing performance and the stripping characteristic of the coating film of the roll product in the cases where the temperature and residence time in the heating zone and the thermal retaining zone were varied as shown in Table 1.

For the evaluation criterion in photographing performance in Table 1, A denotes “excellent”, B denotes “good”, C denotes “moderate” and F denotes “bad”, and A, B and C refer to an acceptable level. Also, in evaluation on the stripping characteristic, A denotes “no stripping found in the film”, B denotes “stripping found in very small part of the film”, C denotes “stripping found in part of the film, but causing no significant problem as a product” and P denotes “stripping found in many parts of the film, thus causing a significant problem as a product”, and A, B and C refer to an acceptable level.

TABLE 1

| | | | Surface temperature | Thermal retaining | | | |
|---|---|---|---|---|---|---|---|
| | Heating zone | | of emulsion layer at | zone | | | Evaluation on |
| | Temp. | Residence | inlet of thermal | Temp. | Residence | Photographing | stripping |
| | (° C.) | time (sec.) | retaining zone (° C.) | (° C.) | time (sec.) | characteristic | charactertistic |
| Example 1 | 98 | 4.7 | 80 | 80 | 3 | A | C |
| Example 2 | 98 | 4.7 | 80 | 80 | 7 | A | B |
| Example 3 | 98 | 4.7 | 80 | 80 | 10 | A | A |
| Example 4 | 98 | 4.7 | 80 | 80 | 20 | A | A |
| Example 5 | 108 | 5.4 | 90 | 90 | 7 | B | A |
| Example 6 | 115 | 6.3 | 100 | 100 | 7 | C | A |
| Example 7 | 73 | 4.7 | 60 | 60 | 7 | A | C |
| Comparative | 60 | 4.7 | 50 | 50 | 20 | A | F |
| Example 1 | | | | | | | |
| Comparative | 120 | 7.5 | 110 | 110 | 20 | F | A |
| Example 2 | | | | | | | |
| Comparative | 115 | 6.3 | 100 | 100 | 65 | F | A |
| Example 3 | | | | | | | |

In Table 1, Examples 1 to 7 represent the case where the thermal treatment carried out with the surface temperature of the coating film kept at 60 to 100° C. (condition 1), and residence time in the thermal retaining zone being in the range of from 1 to 60 seconds (condition 2) were both satisfied.

Also, Comparative Example 1 represents the case where the surface temperature was 50° C., which falls short of the lower limit of condition 1. Comparative Example 2 represents the case where the surface temperature was 110° C., which exceeds the upper limit of condition 1. Comparative Example 3 represents the case where residence time in the thermal retaining zone was 65 seconds, which exceeds the upper limit of condition 2.

As apparent from Table 1, Examples 1 to 7 satisfying conditions 1 and 2 were rated as acceptable in both photographing performance and evaluation on the stripping characteristic. In particular, Examples 3 and 4 were rated as A in both photographing performance and evaluation on the stripping characteristic, and thus photothermographic materials of high quality could be obtained.

If the surface temperature was too low as in Comparative Example 1, the photothermographic material was acceptable in photographing performance but stripping occurred in many parts of the film, which is ascribable to insufficient thermal treatment. On the other hand, if the surface temperature was too high as in Comparative Example 2, no stripping was found in the film but photographing performance was deteriorated, which is ascribable to excessive thermal treatment. If the surface temperature was within condition 1 but residence time was too long to satisfy condition 2 as in Comparative Example 3, no stripping was found in the film but photographing performance was deteriorated, which is also ascribable to excessive thermal treatment.

As described above, according to the method and apparatus for producing photothermographic materials of the present invention, thermal treatment performance is improved, thus making it possible to obtain photothermographic materials excellent in film characteristics of the coating film and sensitivity stability of the emulsion layer. Thus, the possibility that the coating film surface is stripped off during processing such as slitting and that film chips stripped off the coating film surface are introduced in the coating film during processing to cause a failure in a spotted form after the thermal treatment can be reduced.

Moreover, productivity in production of the photothermographic material can be improved.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. A method for producing a photothermographic material, comprising the steps of:
coating a continuously traveling substrate with at least an emulsion layer coating solution containing an organic silver salt, a silver ion reducing agent, a polymer binder and a photosensitive silver halide to thereby form a coating film on the substrate;
drying the coating film; and
performing a thermal treatment for the coating film after the drying step,
wherein the thermal treatment includes:
a heat treatment for quickly increasing a temperature of a surface of the coating film to a thermal treatment temperature in a range of from 60 to 100° C.;
a thermal retaining treatment for keeping the surface temperature of the coating film after the heat treatment, at the thermal treatment temperature for a time period in a range of from 1 to 60 seconds; and
a cooling treatment for forcefully decreasing the surface temperature of the coating film after the thermal retaining treatment, from the thermal treatment temperature to near a room temperature.

2. The method as defined in claim 1, wherein the surface of the coating film is subjected to a moisture conditioning treatment at a relative humidity in a range of from 40 to 90% in addition to the cooling treatment.

3. The method as defined in claim 1, wherein the thermal treatment is performed within 60 seconds after drying is completed in the drying step.

4. The method as defined in claim 3, wherein the surface of the coating film is subjected to a moisture conditioning treatment at a relative humidity in a range of from 40 to 90% in addition to the cooling treatment.

5-13. (cancelled)
